(19) United States
(12) Patent Application Publication
(10) Pub. No.: US 2024/0381490 A1
(43) Pub. Date: Nov. 14, 2024

(54) METHOD AND DEVICE FOR SUPPORTING MULTICAST SERVICE TRANSMISSION

(71) Applicant: Samsung Electronics Co., Ltd., Suwon-si (KR)

(72) Inventors: Hong WANG, Beijing (CN); Lixiang XU, Beijing (CN); Weiwei WANG, Beijing (CN)

(21) Appl. No.: 18/650,751

(22) Filed: Apr. 30, 2024

(30) Foreign Application Priority Data
May 10, 2023 (CN) 202310525146.7
Aug. 8, 2023 (CN) 202310996316.X
Sep. 21, 2023 (CN) 202311227529.2
Feb. 4, 2024 (CN) 202410158815.6

(51) Int. Cl. H04W 76/40; H04L 47/34

(52) U.S. Cl. CPC H04W 76/40; H04L 47/34

(57) ABSTRACT

A method performed by a first network node in a wireless communication system is provided. The method includes determining whether to establish an F1 tunnel with a third node, transmitting, to a second node, a first message including a first indication, wherein the first indication indicates that a user plane between the third node and the first node has not been established, and transmitting, to the third node, a second message including a second indication, wherein the second indication indicates that the user plane between the third node and the first node has not been established.

### CROSS-REFERENCE TO RELATED APPLICATION(S)

This application is based on and claims priority under 35 U.S.C. § 119 (a) of a Chinese patent application number 202310525146.7, filed on May 10, 2023, in the Chinese Intellectual Property Office, of a Chinese patent application number 202310996316.X, filed on Aug. 8, 2023, in the Chinese Intellectual Property Office, of a Chinese patent application number 202311227529.2, filed on Sep. 21, 2023, in the Chinese Intellectual Property Office, and of a Chinese patent application number 202410158815.6, filed on Feb. 4, 2024, in the Chinese Intellectual Property Office, the disclosure of each of which is incorporated by reference herein in its entirety.

### BACKGROUND

### 1. Field

The disclosure relates to wireless communication technology. More particularly, the disclosure relates to a method and device for improved multicast transmission.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources. In order to meet an increasing demand for wireless data communication services since a deployment of fourth generation (4G) communication system, efforts have been made to develop an improved 5G or pre-5G communication system. Therefore, the 5G or pre-5G communication system is also called “beyond 4G network” or “post long term evolution (LTE) system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for dynamically establishing a multicast transmission user plane when a shared access network is a separate architecture.

Another aspect of the disclosure is to provide a method and device for multicast transmission. When the shared access network is a separate architecture, a user plane for transmitting broadcast multicast service is established dynamically, thereby saving access network resources and new radio resources, and improving the utilization efficiency of access network resources and new radio resources.

Additional aspects will be set forth in part in the description which follows and, in part, will be apparent from the description, or may be learned by practice of the presented embodiments.

In accordance with an aspect of the disclosure, a method performed by a first network node in a wireless communication system is provided. The method includes determining whether to establish an F1 tunnel with a third node, transmitting, to a second node, a first message including a first indication, wherein the first indication indicates that a user plane between the third node and the first node has not been established, and transmitting, to the third node, a second message including a second indication, wherein the second indication indicates that user plane between the third node and the first node has not been established.

In some examples, the method further includes storing context information of the second broadcast session.

In some examples, the method further includes transmitting a third message to a fourth network node, the third message includes information indicating that the fourth network node receives data from an F1 tunnel corresponding to the second broadcast session. In some examples, the method further includes transmitting a fourth message to the fourth network node, the fourth message indicates whether the fourth network node establishes an F1 tunnel for the second broadcast session.

In some examples, the fourth message is a context modification request message of the first broadcast session or a context setup request message of the second broadcast session.

In some examples, the method further includes transmitting a fifth message to the second network node, wherein the fifth message includes user plane address information of the second broadcast session.

In some examples, the method further includes transmitting a sixth message to the second network node, indicating whether the second network node establishes an F1 tunnel for the second broadcast session.

In some examples, the sixth message is a bearer modification request message of the first broadcast session or a bearer setup request message of the second broadcast session

In some examples, the first message and the second message further include sequence numbers.

In accordance with another aspect of the disclosure, a method performed by a second network node in a wireless communication system is provided. The method includes detecting an error in a user plane, and transmitting a first message to a first network node, the first message includes a first indication and user plane address information of a second broadcast session, wherein the first indication indicates that an error occurs in the user plane of a first broadcast session.

In some examples, detecting an error in the user plane includes detecting the error in the user plane error through General Packet Radio Service (GPRS) Tunnelling Protocol user plane (GTP-U) mechanism, or detecting the error through the received GTP-U sequence number.

In some examples, the first message further includes the sequence number.

In accordance with another aspect of the disclosure, a method performed by a user equipment UE in a wireless communication system is provided. The method includes receiving a seventh message from a fifth network node, the seventh message includes a multimedia broadcast service (MBS) session identification (ID) and a second indication, wherein the second indication indicates that the UE expects to maintain in a radio resource control (RRC) connected mode to receive MBS, receiving a group paging message from a sixth network node, the group paging message includes a multicast service session ID and a third indication. The third indication indicates that the UE maintains in RRC inactive state to receive MBS, and according to the second indication, entering RRC connected mode to receive MBS.

In some examples, the fifth network node is an access control and mobility management functional entity (AMF) of the core network.

In accordance with another aspect of the disclosure, a method performed by a sixth network node in a wireless communication system is provided. The method includes receiving an eighth message from a fifth network node, the eighth message includes a multicast service MBS session ID and a second indication, wherein the second indication indicates that the UE expects to maintain in a radio resource control RRC connected mode to receive MBS, and receiving an MBS activation request from a fifth network node, transmitting a group paging message to the user equipment UE, the group paging message includes the MBS session ID and a third indication, wherein the third indication indicates that the UE maintains in RRC inactive state to receive MBS.

In some examples, the fifth network node is an access control and mobility management functional entity AMF of the core network.

In some examples, the method further includes transmitting a dedicated paging request message to the UE according to the second indication.

In some examples, the method further includes transmitting, to the UE, a message configuring the UE to enter RRC inactive state, the message carries the MBS session ID and a fourth indication, wherein the fourth indication indicates that the UE maintains in RRC inactive state to receive MBS.

In accordance with another aspect of the disclosure, a first network node in a wireless communication system is provided. The first network node includes a transceiver, memory storing one or more computer programs, and one or more processors communicatively coupled to the transceiver, and the memory, wherein the one or more computer programs include computer-executable instructions that, when executed by the one or more processors, cause the first node to determine whether to establish an F1 tunnel with a third node, transmit, to a second node, a first message including a first indication, wherein the first indication indicates that a user plane between the third node and the first node has not been established, and transmit, to the third node, a second message including a second indication, wherein the second indication indicates that the user plane between the third node and the first node has not been established.

In accordance with another aspect of the disclosure, one or more non-transitory computer-readable storage media storing one or more computer programs including computer-executable instructions that, when executed by one or more processors of a first node, cause the first node to perform operations are provided. The operations include determining whether to establish an F1 tunnel with a third node, transmitting, to a second node, a first message including a first indication, wherein the first indication indicates that a user plane between the third node and the first node has not been established, and transmitting, to the third node, a second message including a second indication, wherein the second indication indicates that the user plane between the third node and the first node has not been established.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a system architecture of system architecture evolution (SAE) according to an embodiment of the disclosure;

FIG. 2 is a schematic diagram of the initial overall architecture of 5G according to an embodiment of the disclosure;

FIG. 3A is a schematic diagram of a method according to an embodiment of the disclosure;

FIG. 3B is a flowchart of a method performed by a first network node according to an embodiment of the disclosure;

FIG. 3C is a flowchart of a method performed by a second network node according to an embodiment of the disclosure;

FIG. 4 is a schematic diagram of a method for establishing a broadcasting service according to an embodiment of the disclosure;

FIG. 5 is a schematic diagram of a method for modifying broadcasting services according to an embodiment of the disclosure;

FIG. 6 is a schematic diagram of a method for establishing the F1 user plane according to an embodiment of the disclosure;

FIG. 7 is a schematic diagram of another method for establishing the E1 user plane according to an embodiment of the disclosure;

FIG. 8 is a schematic diagram of multicast service transmission according to an embodiment of the disclosure;

FIG. 9 is a schematic diagram of another method for multicast service transmission according to an embodiment of the disclosure;

FIG. 10 is a schematic diagram of another method for multicast service transmission according to an embodiment of the disclosure;

FIG. 11 is a block diagram of a communication device according to an embodiment of the disclosure;

FIG. 12 is a schematic diagram of a method for establishing a F1 tunnel according to an embodiment of the disclosure;

FIG. 13 illustrates a block diagram illustrating a structure of a UE according to an embodiment of the disclosure; and

FIG. 14 illustrates a block diagram illustrating a structure of a base station or core network entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which may be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

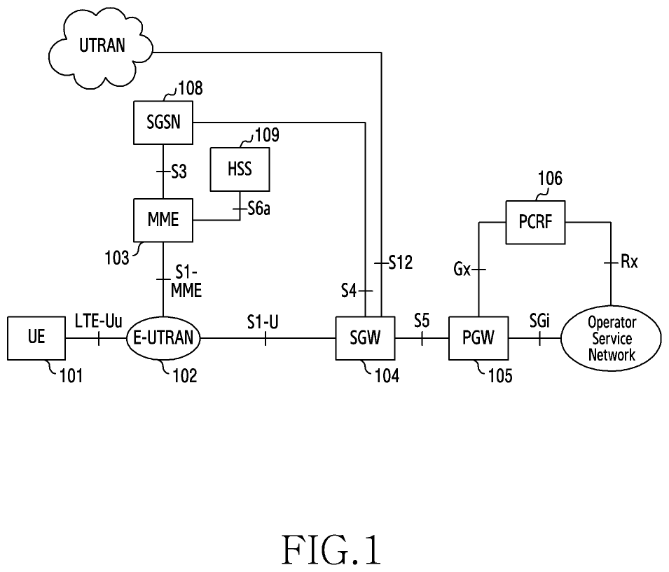

FIGS. 1, 2, 3A to 3C, and 4 to 11 discussed below and various embodiments for describing the principles of the disclosure in this patent document are only for illustration and should not be interpreted as limiting the scope of the disclosure in any way. Those skilled in the art will understand that the principles of the disclosure may be implemented in any suitably arranged system or device.

FIG. 1 is a system architecture 100 of system architecture evolution (SAE) according to an embodiment of the disclosure.

User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

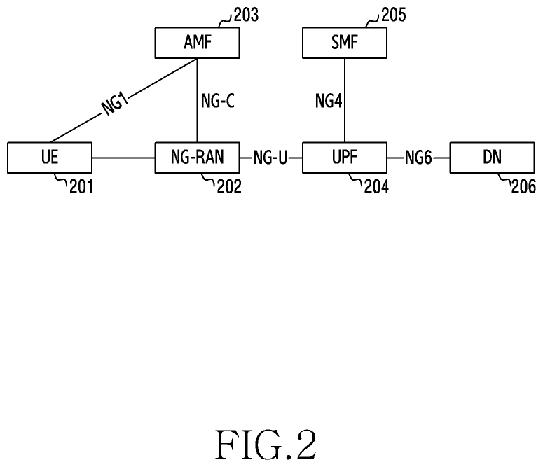

FIG. 2 is a system architecture 200 according to an embodiment of the disclosure. Other embodiments of the system architecture 200 may be used without departing from the scope of the disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

In order to effectively utilize new radio resources, for services with multiple receiving users receiving the same data, broadcast and multicast modes are used to provide service data to the users. This type of service is called Multimedia Broadcast Service (MBS).

MBS services are divided into two types. One is multicast service, where UE needs to join the multicast service first, and then, when the multicast service starts, if UE is in packet mobility management (PMM) idle mode, the network transmits a paging message allowing UE to enter PMM connected mode to receive the service. The other type is broadcast service, where UE does not need to join a certain group, the start information and configuration information of the service will be transmitted to UE through broadcast, and data can be received in all PMM connected modes and PMM idle modes.

When MBS is broadcast service, the base station transmits data to the UE through broadcast, and the UE handling RRC idle and connected modes can receive data of the MBS service. When the base station is in a separate architecture, the Centralized Unit-Control Plane (CU-CP) provides MBS related information to the Distributed Unit (DU), DU generates MBS control messages and MBS broadcast configuration messages, that are transmitted to the UE through a common channel, such as through the MBS Common Control Information (MCCH). For multicast service, CU-CP transmits MBS related configuration information to UE through RRC messages, and only UE in RRC connected mode can receive data of the MBS service.

In the deployment of shared access network, the same MBS service is deployed by two (or more) operators, and each operator assigns a different temporary terminal group ID (TMGI), also known as session ID, to the MBS service. The current mechanism is that the access network identifies MBS services through TMGI, and resource allocation is specific to one TMGI. If the TMGIs are different, the access network will assign different point-to-point resources to transmit MBS data. However, the MBS data transmitted is for the same MBS service, but different resources are used to transmit the data. The resource utilization rate of the network is not high, so it is necessary to adopt enhanced methods to improve resource utilization. When resource problem occurs, an enhanced configuration method is needed to enable MBS data to continue to be transmitted and ensure service continuity. The following is an example of how to enhance an access network shared by two operators. If the access network is shared by more than two operators, a similar method may be used.

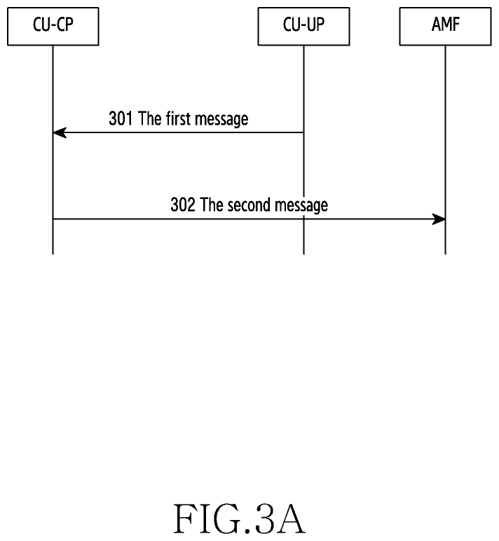

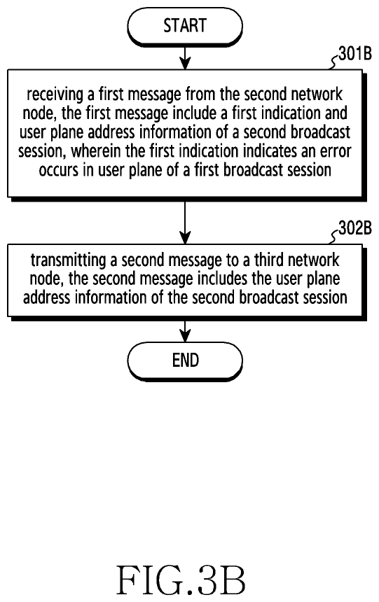

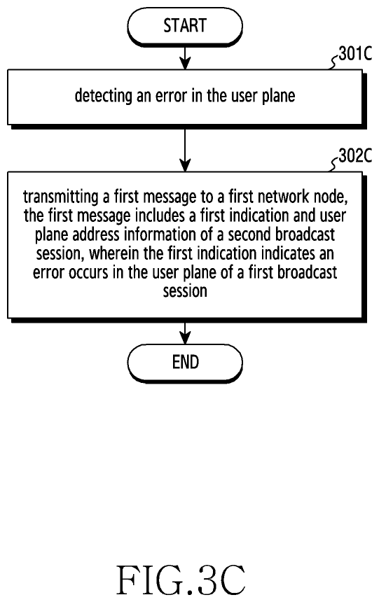

FIG. 3A is a schematic diagram of the method according to an embodiment of the disclosure.

The access network takes a separate architecture as an example. CU-CP, a centralized unit user plane (CU-UP), CU-UP, and DU are shared by two operators. Both operators operate the same MBS service, and the operators assign different MBS session IDs TMGI to the same MBS service. For example, operator 1 uses TMGI1 and the core network is CN1, operator 2 uses TMGI2 and the core network is CN2.

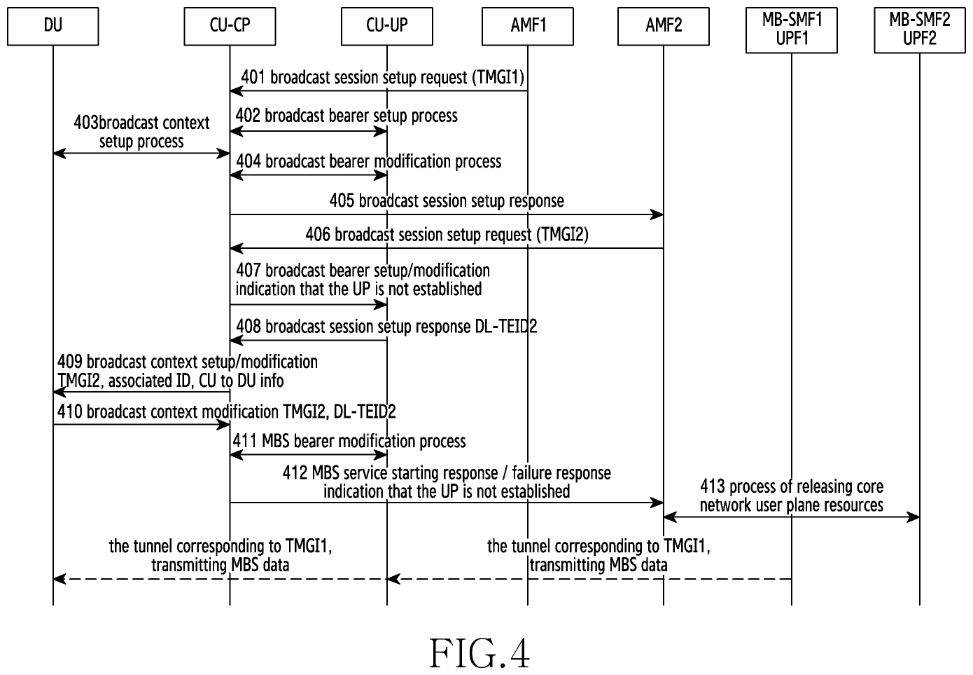

CU-CP receives broadcast session setup request messages from CN1 and CN2 respectively, the two messages include different MBS session IDs TMGI. For example, CN1 assigns the session ID TMGI1 to MBS, while CN2 assigns the session ID TMGI2 to MBS. The broadcast session setup request message also includes the ID associated with MBS, the ID is the information that uniquely identifies an MBS service between operators and may be the internet protocol (IP) address of the MBS application, or other unique ID. According to the same ID associated with MBS included in the broadcast session setup request, CU-CP may know that MBS services with different session IDs belong to the same MBS service. For associated MBS services, in order to save access network resources and reduce repeated data transmission, CU-CP determines the number of user planes between the access network and the core network. For example, CU-CP decides to establish only one user plane, that is, only the user plane between CU-UP and CN1, and not establish the user plane between CU-UP and CN2. The setup of the user plane is described in FIG. 4 below.

CU-UP monitors the established user plane of the MBS and detects errors in the user plane, such as interruption of the tunnel for transmitting data of the user plane between CU-UP and the core network, or loss of data received by CU-UP. The interruption of the tunnel may be known through the current mechanism of the transport layer, and the loss of the data may be known through the sequence number included in the packet header. If this situation is monitored, CU-UP transmits a first message of step 301 to CU-CP. The first message includes the session ID TMGI1 of MBS, and the first message also includes an indication indicating that an error occurs in the user plane. The indication may be explicitly indicated in the first message, Alternatively, it may be indicated by setting the reason as a user plane error. The message may also carry the ID associated with the MBS, and it may also include the MBS session ID TMGI2 under another operator, carry the address information of the user plane assigned to TMGI2 by CU-UP, the address information of the user plane includes the IP address and tunnel endpoint ID TEID.

In step 302, CU-CP transmits a second message to the core network CN2, the second message carries the service ID TMGI2 of MBS under operator 2, includes the ID associated with the MBS, the user plane address information assigned to TMGI2 by CU-UP, and the sequence number of the user plane.

CN2 performs resource allocation within the core network and may then transmit response messages to CU-CP, CU-CP may then transmit response messages to CU-UP. Afterwards, CU-UP may receive MBS data from the CN2 core network.

FIG. 3B is a flowchart of a method performed by a first network node according to an embodiment of the disclosure.

In operation 301B, the first network node receives a first message from a second network node, the first message may include a first indication indicating that an error occurs in the user plane of a first broadcast session. The first message may also include user plane address information of a second broadcast session.

In operation 302B, the first network node transmits a second message to a third network node, the second message includes the user plane address information of the second broadcast session.

FIG. 3C is a flowchart of a method performed by a second network node according to an embodiment of the disclosure.

In operation 301C, the second network node detected an error in the user plane.

In operation 302C, the second network node transmits a first message to the first network node, the first message may include a first indication indicating that an error occurs in the user plane of the first broadcast session. The first message may also include user plane address information of the second broadcast session.

In various embodiments disclosed in this disclosure, CU-CP may also be referred to as the first network node, CU-UP may also be referred to as the second network node, AMF2 of operator 2 may also be referred to as the third network node, and DU may also be referred to as the fourth network node.

FIG. 4 depicts an embodiment of establishing a user plane for broadcasting service according to an embodiment of the disclosure.

The access network is a separate architecture shared by two operators. The separated access network includes CU-CP, CU-UP, and DU. The same MBS broadcast session is provided in the networks of two operators, and the broadcast session IDs assigned to the broadcast session by the two operators are TMGI1 and TMGI2 respectively. The GPRS Tunnelling Protocol (GTP) user plane tunnelling protocol is used in the NG interface user plane and F1 interface user plane.

In step 401, CU-CP received the first broadcast session setup request message transmitted by the core network access and mobility management function (AMF1).

The core network belonging to operator 1 transmits the first broadcast session setup request message to CU-CP. The broadcast session setup request message includes the NG interface ID assigned to TMGI1 by core network 1, MBS session ID, such as TMGI1, MBS service coverage, such as a set of service area IDs (such as SAI), a set of cell IDs (such as cell global identity (CGI)), or a set of routing area IDs (such as tracking area identity (TAI) or tracking area code (TAC)), the transport layer address information of the NG user plane, wherein the transport layer address information includes IP address and tunnel endpoint ID TEID. The message also includes information about the MBS Quality of Service flow (QOS flow) to be established, such as the ID of the QoS flow and the QoS requirement of the QoS flow.

In order to save equipment investment from operators, network sharing is a common deployment method. Network sharing is the same access network device used by multiple operators. MBS services may be broadcasted across multiple operators, and different operators may assign different MBS session IDs (TMGI) to the same MBS service. Currently, access network identifies different MBS services via TMGIs. If TMGIs are different, the MBS services are considered as different MBS services. The access network assigns different access network resources and new radio resources to transmit MBS data of actually the same service. In order to reduce the resource consumption of wireless networks and new radio, if one node supports multiple operators, for the same MBS service, the access network may assign the same network resources and new radio resources to transmit data belonging to the same MBS service received from different core networks. To achieve this, the message in step 401 may also include the ID associated with MBS, which is an MBS unique service ID that uniquely identifies an MBS service. For the same MBS service, the MBS unique service ID is the same across different operator networks.

In step 402, the broadcast bearer setup procedure between CU-CP and CU-UP.

This procedure includes transmitting a broadcast bearer setup request message to CU-UP by CU-CP and transmitting a response message to CU-CP by CU-UP.

During the procedure of E1 setup request, CU-CP obtains the operator ID supported by CU-UP, thereby knowing that CU-UP is a node shared by multiple operators. After receiving the message of step 401, CU-CP transmits the broadcast bearer setup request message to CU-UP, the message includes the E1 interface ID assigned to TMGI1 by CU-CP, MBS session ID TMGI1, slice ID, transport layer address of MBS session in the core network 5GC, list of MBS unlimited bearers (MRBs) to be established, the list includes ID of MRB and QoS flow information. CU-UP transmits a broadcast bearer setup response message to CU-CP.

The message includes the E1 interface ID assigned to TMGI1 by CU-UP, the MBS session ID TMGI1, the NG user plane transport layer address assigned by CU-UP. The message further includes the successfully established list of MRBs, the list includes the ID of the MRB, the ID of successfully established QoS flow, and the transport layer address assigned to F1 user plane by CU-UP. The transport layer address includes the IP address and TEID of the F1 user plane. Each MRB corresponds to an F1 tunnel.

In step 403, the broadcast context setup procedure between CU-CP and DU.

This procedure includes transmitting a broadcast context setup request message to DU by CU-CP and a broadcast context setup response message to CU-CP by DU.

CU-CP receives a broadcast bearer setup response message from CU-UP, obtains the transport layer address information of the F1 user plane assigned to MRB by CU-UP. CU-CP transmits a broadcast context setup request message to DU, the message includes the F1 interface ID assigned to TMGI1 by CU-CP, the MBS session ID TMGI1, the MBS service coverage, such as a set of service area IDs (such as SAI), or a set of cell IDs (such as CGI), or a set of routing area IDs (such as TAI or TAC), wherein the message includes MBS CU to DU (CU to DU) RRC information. The MBS CU to DU RRC information includes a list of cells broadcasted by MBS and a list of adjacent cells broadcasting the MBS services. The MBS CU to DU RRC information further includes MRB PDCP configuration. The broadcast service context setup request message further includes information about the MBS radio bearer to be established, such as the ID of the MRB, the quality requirements of the MRB, the ID of the QoS flow mapped to the MRB, the QoS requirement of the QoS flow, and the transport layer address of the broadcast bearer in CU-UP.

DU stores MBS context information, assigns resources according to the configuration, and transmits a broadcast context setup response message to CU-CP. The response message includes the F1 interface ID assigned to TMGI1 by DU, the MBS session ID TMGI1, ID of the successfully established MRB, and the transport layer address information of the F1 user plane assigned to MRB of TMGI1 by DU.

In step 404, the broadcast bearer modification procedure between CU-CP and CU-UP.

This procedure includes transmitting a broadcast bearer modification request message by C to CU-UP CU-CP and transmitting a broadcast bearer modification response message by to CU-CP CU-UP.

CU-CP obtains the transport layer address of the F1 user plane assigned to MRB by DU from DU. CU-CP transmits the broadcast bearer modification request to CU-UP, the requests includes the E1 interface ID assigned to TMGI1 by CU-CP, the MBS session ID TMGI1, and a list of MRBs to be established or modified, the list of MRB includes the IDs of MRBs, and the transport layer address assigned to F1 user plane by DU.

CU-UP stores the received information and transmits the broadcast bearer modification response message to CU-CP. The message includes the E1 interface ID assigned to TMGI1 by CU-UP, the MBS session ID TMGI1, and the successful established list of MRBs.

In step 405, CU-CP transmits the broadcast session setup response message to AMF1.

The message includes the NG interface ID assigned to TMGI1 by CU-CP, the MBS session ID TMGI1, and the transport layer address assigned to the NG user plane of TMGI1 by CU-UP.

In step 406, CU-CP receives a second broadcast session setup request message from AMF2 of operator 2. The second broadcast message includes the NG interface ID assigned to TMGI2 by core network 2, the MBS session ID TMGI2, and the message may further include the ID associated with MBS. If the first broadcast session setup request message and the second broadcast session setup request message include the same ID associated with MBS, CU-CP may know that the MBS corresponding to the two messages is the same MBS service. Due to the same services being transmitted, the access network NG-RAN is shared. CU-CP may decide whether to establish a user plane for transmitting MBS services between the access network and core network 2. For the effective utilization of resources, CU-CP may decide to only establish a user plane for access network and core network 1, or to establish a user plane between access network and core network 1 and between access network and core network 2 respectively.

If CU-CP decides to only establish the user plane between access network and core network 1, and not to establish the user plane between access network and core network 2, CU-CP can perform one of the following operations:

In one method, CU-CP stores the context information related to TMGI2, the context information related to TMGI2 includes the MBS session ID TMGI2 received from the core network, the service coverage of TMGI2, the ID associated with MBS, slice ID, the transport layer address of MBS session in the core network 5GC, the QoS flow information of MBS, frequency information, etc. CU-CP does not transmit any messages to CU-UP. CU-UP does not know the information related to TMGI2, therefore CU-UP cannot establish a user plane with core network 2 for transmitting MBS. When CU-CP knows through the methods shown in FIGS. 4 to 7 of the disclosure that the MBS data content transmitted by TMGI1 and TMGI2 are same, and the RAN is shared, the NG-U tunnel between CU-UP and TMGI1 core network has been established before, and there is an error in the established NG-U user plane, CU-CP will transmit an MBS bearer setup request for TMGI2 to CU-UP, and CU-UP assigns the TNL address of NG-U to TMGI2 and transmits it to CU-CP through a response message, then CU-CP can transmit a message to the core network control node of TMGI2, such as access and mobility function entity AMF or session management entity SMF or MBS session management entity MBS-SMF. The message includes the MBS service ID TMGI2, the TNL address assigned by NG-RAN, that is, the TNL address assigned to TMGI2 by CU-UP. The message may further include GTP-SN, which is transmitted by CU-UP when indicating a user plane error. Upon receiving this message, the core network of TMGI2 can establish an NG-U tunnel between the core network user plane (UPF or MBS UPF) and CU-UP, and the user plane begins to transmit MBS data to CU-UP. If the message includes GTP-SN, the core network user plane starts transmitting from the data packet indicated by the GTP-SN. Since the MBS data of TMGI2 is actually the same as the MBS data of TMGI1, the data may be transmitted through the user plane of TMGI2 to ensure data continuity when there is an error in the user plane of TMGI1. Through the GTP-SN, the user plane of TMGI2 may be informed from which data packet to start transmitting, which makes data transmission more accurate and does not reduce data transmission interruptions due to transmitting less data, and will not cause repeated data transmission due to repeated transmission neither.

In another method, CU-CP stores the context information related to TMGI2. CU-CP transmits MBS bearer modification request message of step 407 to CU-UP, the message includes the E1 interface ID assigned to TMGI1 by CU-CP, the MBS session ID TMGI1, the ID associated with MBS. The message further includes the MBS session ID TMGI2, the transport layer address of MBS session in the core network 2, the indication indicating that the user plane is not established. By receiving the indication, CU-UP does not assign the transport layer address of NG-U interface to TMGI2, so the user plane between CU-UP and core network 2 for transmitting MBS data is not established. Through the ID associated with MBS, CU-UP can know that the MBS services corresponding to TMGI1 and TMGI2 are same, and CU-UP stores the context information related to TMGI2. The message may further include a list of MRBs to be established or modified, the list of MRBs includes the IDs of MRBs. The list of MRBs may be same as the list of MRBs included in step 402, that is, the MRB configurations for TMGI1 and TMGI2 are same. CU-UP assigns the transport layer address of the F1 user plane to the MRB of TMGI2. CU-UP can reuse the transport layer addresses of the F1 user plane assigned to the MRB of TMGI1 in step 402, that is, the data of TMGI1 and TMGI2 are transmitted to DU through the same F1 tunnel.

In another method, CU-CP stores the context information related to TMGI2. CU-CP transmits the MBS bearer request message of step 407 to CU-UP, the message includes the E1 interface ID assigned to TMGI2 by CU-CP, the MBS session ID TMGI2, the ID associated with MBS, the slice ID, the transport layer address of MBS session in core network 2, the list of MRBs to be established, and the list of MRBs to be established includes the IDs of the MRBs and QoS flow information. The message further includes an indication indicating not to establish a user plane. By receiving the indication, CU-UP does not assign the transport layer address of the NG-U interface, so that the user plane between CU-UP and Core Network 2 for transmitting MBS data is not established. Through the ID associated with MBS, CU-UP may know that the MBS services corresponding to TMGI1 and TMGI2 are same, and CU-UP stores the context information related to TMGI2. The list of MRBs may be different from the list of MRBs included in step 402, that is, the MRB configurations of TMGI1 and TMGI2 are different. CU-UP assigns the transport layer address of the F1 user plane to the MRB of TMGI2. CU-UP assigns different F1 user plane transport layer addresses to the MRB of TMGI2, that is, the data of TMGI1 and TMGI2 are transmitted to DU through different F1 tunnels.

In the fourth method, CU-CP stores the context information related to TMGI2, and transmits MBS bearer request message of step 407 to CU-UP, the message includes the E1 interface ID assigned to TMGI2 by CU-CP, the MBS session ID TMGI2, the ID associated with MBS, the slice ID, the transport layer address of MBS session in core network 2, the list of MRBs to be established, the list of MRBs to be established includes the IDs of MRBs and QoS flow information, and the message further includes a third indicator information. For example, the third indication is an indication indicating that NG-U is not established. By receiving the indication, CU-UP assigns the transport layer address of the NG-U interface, and CU-UP knows that the NG-U tunnel between CU-UP and the core network user plane is not established. Through the ID the associated MBS included in the message, CU-UP can know that the MBS services corresponding to TMGI1 and TMGI2 are same, and CU-UP stores the context information related to TMGI2. The list of MRBs may be same as the list of MRBs included in step 402, that is, the MRB configurations for TMGI1 and TMGI2 are same. When the network is shared and different TMGIs transmitted by multiple operators transmit the same MBS data, only one shared F1-U tunnel between CU-UP and DU may be established. Therefore, the third indication may also indicate that CU-UP does not need to assign CU-UP and F1-U tunnel information to TMGI2. On the NG interface, in this example, the MBS service ID provided by operator 1 is TMGI, and the MBS service ID provided by operator 2 is TMGI2. The MBS data content transmitted by TMGI1 and TMGI2 are same. NG-RAN is shared by operator 1 and operator 2. In this method, NG-RAN decides to establish an NG-U tunnel between the core network of operator 1, and CU-CP node of NG-RAN indicates one or more of the following information to CU-UP through the first indication:
indicating CU-UP to assign a Transport Network Layer TNL address for the NG-U tunnel to the TMGI2, wherein the TNL address includes an IP address and GTP-TEID. The third indication further indicates that the NG-U tunnel between CU-UP and the core network of the TMGI2 is not established, or will not be established, or is temporarily not established. According to the third indication, CU-UP knows that it will not receive MBS data transmitted by the core network from the NG-U tunnel temporarily. By receiving the third indication, CU-UP assigns the TNL address of the NG-U tunnel that is used to receive MBS data from the core network. The bearer setup response message including the address is transmitted to CU-CP through step of 408; through the third indication, CU-UP knows that CU-CP does not establish the user plane between CU-UP and the TMGI2 core network, and NG-U is not established successfully. CU-UP will not receive MBS data transmitted by the core network from the NG-U tunnel, and CU-UP will not determine that the failure to receive data on NG-U is an error.
indicating that CU-UP does not establish NG-U. The third indication indicates that the NG-U tunnel between CU-UP, CU-CU, and the core network of the TMGI2 is not established, will not be established, or is temporarily not established. By receiving the third indication, CU-UP will still assign the TNL address of the NG-U tunnel to TMGI2. The NG-U tunnel is used to receive MBS data from the core network, and the bearer setup response message including the address is transmitted to CU-CP through step of 408. Through the third indication, CU-UP knows that CU-CP does not establish the user plane between CU-UP and the TMGI2 core network, and NG-U is not established successfully. CU-UP will not receive MBS data transmitted by the core network from the NG-U tunnel, and CU-UP will not determine that the failure to receive data on NG-U is an error.
indicating CU-UP to assign the TNL address of the F1-U tunnel to the MRB of the TMGI2. The MBS bearer request message includes the configuration information of the MRB corresponding to TMGI2. To share resources, the MRB configuration information corresponding to TMGI2 may be the same as the MRB configuration information corresponding to TMGI. The third indication indicates that CU-UP needs to assign the TNL address of the F1-U tunnel to the MRB of TMGI2. To share resources, CU-UP may assign the TNL address of the F1-U tunnel to the MRB of TMGI2, which may be the same as the TNL address of the F1-U tunnel previously assigned to the MRB of TMGI1 in step 402.

By receiving the response message of step 408, CU-CP stores the address information. When CU-CP decides to establish an NG-U tunnel between the core network of TMGI2, for example, when CU-CP knows through the methods shown in FIGS. 4 to 7 of the disclosure that the MBS data content transmitted by TMGI1 and TMGI2 are same and the RAN is shared, the NG-U tunnel between CU-UP and TMGI1 has already been established, and there is an error in the established NG-U user plane. If CU-CP has stored the TNL address of the NG-U tunnel assigned to TMGI2 by CU-UP, CU-CP may directly transmit a message to the core network control node of TMGI2, such as access and mobility function entity AMF or session management entity SMF or MBS session management entity MBS-SMF. The message includes the MBS service ID TMGI2, the TNL address assigned by NG-RAN, that is, the TNL address of NG-U assigned to TMGI2 by CU-UP. The message may further include GTP-SN, which is transmitted by CU-UP when a user plane error is indicated. By receiving the message, the core network of TMGI2 may establish an NG-U tunnel between the core network user plane (UPF or MBS UPF) and CU-UP, and the user plane begins to transmit MBS data to CU-UP. If the message includes GTP-SN, the core network user plane starts transmitting the data packet indicated by the GTP-SN. Because the MBS data of TMGI2 is actually the same as the MBS data of TMGI1, it may be transmitted through the user plane of TMGI2 to ensure data continuity when there is an error the user plane of TMGI1. Through the GTP-SN, the user plane of TMGI2 may be informed from which data packet to start transmitting, which makes data transmission more accurate and does not reduce data transmission interruptions due to transmitting less data, and will not cause repeated data transmission due to repeated transmission neither.

The above CU-CP node transmits the first indication to indicate CU-UP, which may also occur in subsequent steps, such as the broadcast bearer modification process shown in step 411. Through the broadcast bearer modification request message, the first indication is transmitted to CU-UP, which depends on when CU-CP can make the decision of not establishing an NG-U tunnel. If the decision is made earlier, the first indication may be transmitted to CU-UP in the bearer setup request message. If the decision is made later, the first indication may be transmitted to CU-UP in subsequent broadcast bearer modification request.

If CU-CP decides to establish a user plane between access network and core network 2, CU-CP can repeat step 402.

In step 408, CU-UP transmits a broadcast bearer modification response or setup response message to CU-CP.

According to the different methods in step 407, CU-UP can transmit a broadcast bearer modification response message to CU-CP, the message includes the E1 interface ID assigned to TMGI1 by CU-UP, the MBS session ID TMGI1, and the MBS session ID TMGI2 and the successful established list of MRBs, the successful established list of MRBs includes the IDs of MRBs, and the transport layer address assigned to the F1 user plane by CU.

According to the different methods in step 407, CU-UP can transmit a broadcast bearer setup response message to CU-CP, the message includes the E1 interface ID assigned to TMGI2 by CU-UP, the MBS session ID TMGI2, and the successful established list of MRBs, the successful established list of MRBs includes the IDs of MRBs, and the transport layer address assigned to the F1 user plane by CU-UP.

In step 409, CU-CP transmits a broadcast service context modification or setup request message to DU.

In one method, CU-CP transmits a broadcast context modification request message to DU, the message includes the F1 interface ID assigned to TMGI1 by CU-CP, MBS session ID TMGI1, MBS associated ID, MBS service coverage, MBS session ID TMGI2, and MBS CU to DU RRC information. The MBS CU to DU RRC information includes the list of cells of TMGI2 and the list of adjacent cells broadcasting the MBS service. The MBS CU to DU RRC information further includes the MRB PDCP configuration. The broadcast service context setup request message further includes information about the MBS radio bearer to be established, such as the ID of MRB, the quality requirements of the MRB, the ID of the QoS flow mapped to the MRB, and the QoS requirement of the QoS flow. Broadcast is carried on the transport layer address of CU-UP. The message may include multiple MBS CU to DU RRC information corresponding to TMGI1 and TMGI2 respectively. For TMGI1 and TMGI2, the same MRB may be configured and the same F1 tunnel may be used.

In another method, CU-CP transmits a broadcast context setup request message to DU, the message includes the F1 interface ID assigned to TMGI2 by CU-CP, MBS session ID TMGI2, MBS associated ID, MBS service coverage, such as a set of service area IDs (such as SAI), a set of cell IDs (such as CGI), or a set of routing area IDs (such as TAI, or TAC). The message includes MBS CU to DU RRC information. The MBS CU to DU RRC information includes a list of cells broadcasted by MBS and a list of adjacent cells broadcasting the MBS services. The MBS CU to DU RRC information further includes MRB PDCP configuration. The broadcast service context setup request message further includes information about the MBS radio bearer to be established, such as the ID of the MRB, the quality requirements of the MRB, the ID of the QoS flow mapped to the MRB, and the QoS requirement of the QoS flow. Broadcast is carried on the transport layer address of CU-UP.

In step 410, DU transmits a response message to CU-CP.

In one method, DU transmits a broadcast context modification response message to CU-CP. The response message includes the F1 interface ID assigned to TMGI1 by DU, the MBS session ID TMGI1, the ID associated with MBS, the MBS session ID TMGI2, ID of the successfully established MRB, and the transport layer address information of the F1 user plane assigned to TMGI1 and TMGI2 by DU. For TMGI1 and TMGI2, the same MRB may be configured and the same F1 tunnel may be used.

In another method, DU transmits a broadcast context setup response message to CU-CP. The response message includes the F1 interface ID assigned to TMGI2 by DU, the MBS session ID TMGI2, the ID associated with MBS, ID of the successfully established MRB, and the transport layer address information of the F1 user plane assigned to TMGI2 by DU. For TMGI1 and TMGI2, the same or different MRBs may be configured and different F1 tunnels may be used.

In step 411, the broadcast bearer modification procedure between CU-CP and CU-UP.

This procedure includes transmitting a broadcast bearer modification request message to CU-CP by CU-CP and a broadcast bearer modification response message by to CU-CP CU-UP.

CU-CP obtains the transport layer address assigned by to the F1 user plane DU from DU, and transmits a broadcast bearer modification request to CU-UP. The message includes the E1 interface ID assigned to TMGI2 by CU-CP, the MBS session ID TMGI2, the ID associated with MBS, and the list of MRBs to be established or modified, the list of MRBs includes the IDs of MRBs, and the transport layer address assigned to the F1 user plane by DU.

Alternatively, the broadcast bearer modification request message includes the E1 interface ID assigned to TMGI1 by CU-CP, MBS session ID TMGI1, MBS associated ID, MBS session ID TMGI2, and a list of MRBs to be established or modified, the list of MRBs includes the IDs of MRBs, and the transport layer address assigned by DU to the F1 user plane.

CU-UP stores the received information and transmits a broadcast bearer modification response message to CU-CP. The message includes the E1 interface ID assigned to TMGI2 by CU-UP, the MBS session ID TMGI2, the ID associated with MBS, and the successful established list of MRBs.

Alternatively, the broadcast bearer modification response message includes the E1 interface ID assigned to TMGI1 by CU-UP, MBS session ID TMGI1, MBS associated ID, MBS session ID TMGI2, and the successfully established list of MRBs.

In step 412, CU-CP transmits a broadcast session setup response message or a service failure response message to the core network CN2.

The message includes the NG interface ID assigned to TMGI2 by CU-CP, MBS session ID TMGI2, the ID associated with MBS, an indication indicating that the NG user plane is not established, indicating that the NG interface user plane is not established, or indicating that the NG interface user plane is not established due to shared access network.

In step 413, core network procedure. AMF informs MBS session management function MB-SMF and/or user plane UPF that the NG interface user plane is not established, or informs that the NG interface user plane is not established due to sharing access network.

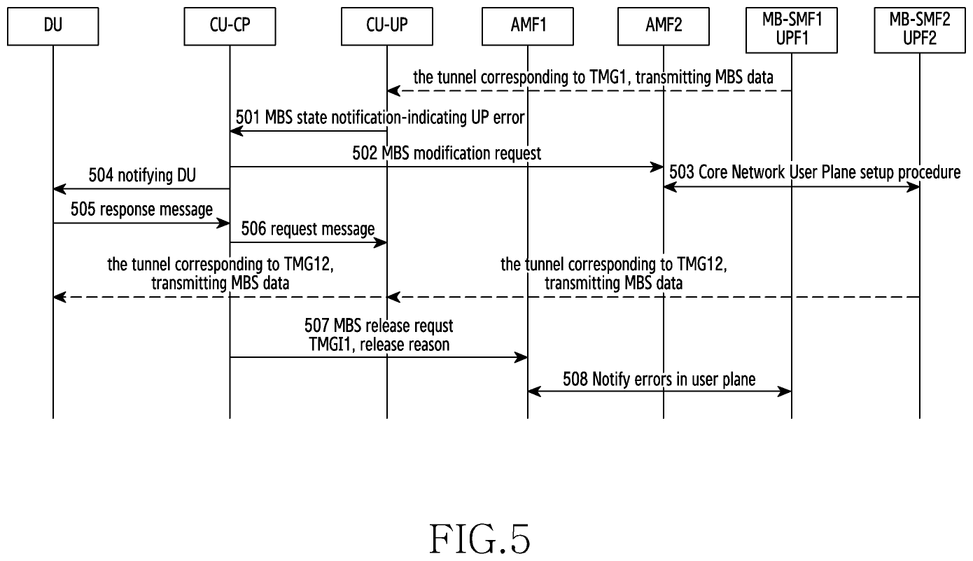

FIG. 5 depicts an embodiment of establishing a user plane for broadcasting services according to an embodiment of the disclosure.

The access network is a separate architecture shared by two operators. The separated access network consists of a central unit control plane (CU-CP), a central unit user plane (CU-UP), and a distribution unit (DU). The same MBS broadcast session is provided in the networks of two operators, and the broadcast session IDs assigned by the two operators to the broadcast session are TMGI1 and TMGI2, respectively. The GTP user plane tunnelling protocol is used in the NG interface user plane and F1 interface user plane. CU-CP establishes a user plane for the MBS between CU-UP and CN1, but does not establish a user plane for the MBS between CU-UP and CN2. CN1 transmits MBS data whose ID is TMGI1, CN2 transmits MBS data whose ID is TMGI2, and TMGI1 and TMGI2 are shared MBS services. The transmitted data are actually same.

Step 501: CU-UP transmits an MBS modification request message to CU-CP.

CU-UP detects some errors in the NG interface user plane corresponding to TMGI1. The errors in the user plane were detected through the mechanism of the GTP-U protocol itself, or through the received GTP-U sequence number. CU-UP transmits a message to CU-CP, the message includes the E1 interface ID assigned to TMGI1 by CU-UP, the MBS session ID TMGI1, the ID associated with MBS, and an indication indicating that an error occurs in the NG user plane. The indication indicates that an error occurs in data reception on the user plane. The message may further include the MBS session ID TMGI2, and the NG interface user plane transport layer address assigned to TMGI2 by CU-UP. The message may further include the list of MRBs of TMGI2, the list of MRBs includes the IDs of MRBs, and the transport layer address of the F1 user plane assigned to the MRB by CU-UP.

Alternatively, CU-UP can transmit a message to CU-CP, the message includes the E1 interface ID assigned to TMGI2 by CU-UP, the MBS session ID TMGI2, the ID associated with MBS, and the NG interface user plane transport layer address assigned to TMGI2 by CU-UP. The message further includes an indication indicating that an error occurs in the NG user plane, the indication indicates that an error occurs in data reception on the NG interface user plane of TMGI1. The message may further include the list of MRBs of TMGI2, the list of MRBs includes the IDs of MRBs, and the transport layer address of the F1 user plane assigned to the MRB by CU-UP.

The message in step 501 further includes the sequence number of GTP-U, the sequence number indicates the highest GTP-U sequence number corresponding to the data packet received by CU-UP, or the GTP-U sequence number corresponding to the next data packet that CU-UP expects to receive. The sequence number of GTP-U may also be other sequence numbers, such as the sequence number of PDCP.

Step 502: CU-CP transmits a broadcast modification request message to the core network AMF2, and the message name may be another message name.

The message includes the E1 interface ID assigned to TMGI2 by CU-UP, the MBS session ID TMGI2, the ID associated with MBS, and the NG interface user plane transport layer address assigned to TMGI2 by CU-UP. The message further includes the sequence number of GTP-U, the sequence number indicates the highest GTP-U sequence number corresponding to the data packet received by CU-UP, or the GTP-U sequence number corresponding to the next data packet that CU-UP expects to receive.

Step 503: AMF2 transmits a message to MBS session management function MB-SMF and/or user plane UPF, informing CU-UP of the assigned NG interface user plane transport layer address.

Step 504: CU-CP transmits a message to DU, informing DU to receive data from the F1 tunnel corresponding to TMGI2. The message may be broadcast context modification request or setup request, or the message name may be another message name.

The message includes the F1 interface ID assigned to TMGI1 by CU-CP, the MBS session ID TMGI1, the ID associated with MBS, the MBS session ID TMGI2, and the message may further include the list of MRBs for TMGI2, the list of MRBs includes the IDs of MRBs, and the transport layer address of the F1 user plane assigned to MRB by CU-UP. The message further includes an indication indicating to receive data from the F1 tunnel corresponding to TMGI2.

Alternatively, the message includes the NG interface ID assigned to TMGI2 by CU-CP, the MBS session ID TMGI2, and the ID associated with MBS. The message may further include the list of MRBs of TMGI2, the list of MRBs includes the IDs of MRBs, and the transport layer address of the F1 user plane assigned to MRB by CU-UP. The message further includes an indication indicating to receive data from the F1 tunnel corresponding to TMGI2.

In step 505, DU transmits a response message to CU-CP.

The response message includes the F1 interface ID assigned to TMGI1 by DU, the MBS session ID TMGI1, the ID associated with MBS, and the MBS session ID TMGI2. The message may further include the list of MRBs for TMGI2, the list of MRBs includes the IDs of MRBs, and the transport layer address of the F1 user plane assigned to MRB by DU.

Alternatively, the response message includes the F1 interface ID assigned to TMGI2 by DU, the MBS session ID TMGI2, the ID associated with MBS, the list of MRBs of TMGI2, the list of MRBs includes the IDs of MRBs, and the transport layer address of the F1 user plane assigned to MRB by DU.

In step 506, CU-CP transmits a message to CU-UP. The message may be a broadcast bearer modification request message, or the message name may be another message name. For example, the broadcast bearer modification acknowledge message. This step message may be transmitted after step 502 and is a response message to step 502.

The message includes the E1 interface ID assigned to TMGI1 by CU-CP, the MBS session ID TMGI1, the ID associated with MBS, the MBS session ID TMGI2, and the message may also include the list of MRBs of TMGI2, the list of MRBs includes the IDs of MRBs, and NG interface user plane transport layer address assigned to TMGI2 by DU. The MBS session ID TMGI2 is the session associated with TMGI1, that is, TMGI2 and TMGI1 transmit the same MBS service data. The message further includes an indication indicating that the data will be transmitted from the CN2 corresponding to TMGI2 to CU-UP.

Alternatively, the message includes the E1 interface ID assigned to TMGI2 by CU-CP, the MBS session ID TMGI2, and the ID associated with MBS. The message may further include the list of MRBs of TMGI2, the list of MRBs includes the IDs of MRBs, and the NG interface user plane transport layer address assigned to TMGI2 by DU. The MBS session ID TMGI1 is the session associated with TMGI2, that is, TMGI1 and TMGI2 transmit the same MBS service data. The message further includes indication indicating that the data will be transmitted from the CN2 corresponding to TMGI2 to CU-UP.

The specific configurations in the list of MRBs of TMGI2 may be the same as those in the list of MRBs previously assigned to TMGI1.

By receiving the message from step 506, storing the information, configuring PDCP and MRB based on the information, and receiving the acknowledge message, CU-UP will know to receive MBS data from CN2.

In step 507, CU-CP transmits an MBS release request message to AMF.

The message includes the E1 interface ID assigned to TMGI1 by CU-CP, and the MBS session ID TMGI1. The release reason is due to access network sharing or due to an error occurring in the NG user plane.

In step 508, AMF1 transmits a message to MB-SMF1 or UPF1 to inform TMGI1 of the error in the corresponding user plane, and UPF1 can stop transmitting data to CU-UP.

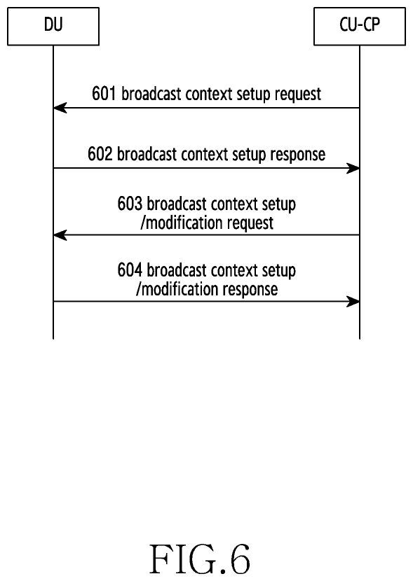

FIG. 6 depicts the procedure of establishing the F1 tunnel according to an embodiment of the disclosure.

TMGI1 and TMGI2 are for the same MBS service. For the same service, F1 tunnels for MRB of TMGI1 and F1 tunnels for MRB of TMGI2 may be established on F1, respectively. The data of TMGI1 and TMGI2 may be transmitted through different tunnels. The MRB configuration of both may be same or different, and DU only broadcasts the configuration information of one MRB on the new radio. In this embodiment, the F1 user planes of TMGI1 and TMGI2 need to be established on F1, but there is no MBS data to be transmitted on the F1 user plane of TMGI2. Alternatively, only one F1 tunnel may be established on F1 to transmit MRB data for TMGI1 and TMGI2.

In step 601, CU-CP transmits a broadcast context setup request message to DU.

The message includes the F1 interface ID assigned to TMGI1 by CU-CP, the MBS session ID TMGI1, the ID associated with MBS, the MBS service coverage, and MBS CU to DU RRC information. The MBS CU to DU RRC information includes a list of cells of TMGI1 and a list of adjacent cells broadcasting the MBS service. The MBS CU to DU RRC information further includes MRB PDCP configuration. The broadcast service context setup request message further includes information about the MBS radio bearer to be established, such as the ID of the MRB, the quality requirements of the MRB, the ID of the QoS flow mapped to the MRB, and the QoS requirement of the QoS flow. Broadcast is carried on the transport layer address of CU-UP.

If CU-CP further receives a broadcast session setup request message from TMGI2 transmitted by CN2 before transmitting the message in step 601, CU-CP can transmit the information of TMGI1 and TMGI2 together to DU through a message. The message may further include the MBS session ID TMGI2, the service coverage of the MBS corresponding to TMGI2, and the MBS CU to DU RRC information related to TMGI2. At this time, the same tunnel is established for TMGI1 and TMGI2 to transmit data.

If TMGI1 and TMGI2 are transmitted through different CU-CPs, that is, CU-CP is not shared by TMGI1 and TMGI2. CU-CPs transmit broadcast context request messages to DU, respectively. Through the same ID associated with MBS included in different broadcast context request messages, DU may know that the transmitted services are relevant although the broadcast context request messages are different, and the transmitted service data are actually same.

In step 602, DU transmits a broadcast context setup response message to CU-CP.

The message includes the F1 interface ID assigned to TMGI1 by DU, the MBS session ID TMGI1, the ID associated with MBS, the ID of the successfully established MRB, and the transport layer address information of the F1 user plane assigned to TMGI1 by DU.

If CU-CP is not shared by TMGI1 and TMGI2, and DU receives broadcast session setup requests from TMGI1 and TMGI2, respectively, through the same ID associated with MBS included in the session setup request message, DU knows that TMGI1 and TMGI2 transmits the same MBS data. Therefore, DU may decide to use resource optimization methods, such as not establishing an F1 user plane for TMGI2. DU transmits broadcast context setup response messages to CU-CP1 and CU-CP2, respectively.

The information related TMGI2 and TMGI1 is transmitted through different F1 control signals, with different CU-CPs. Therefore, different F1 control signals transmit different IDs of MRBs, MRB PDCP configurations and other information are different, either. DU selects ID of MRB and MRB PDCP configuration for use in the broadcast of new radio. For example, if the ID of MRB and MRB PDCP configuration corresponding to TMGI1 are selected, DU transmits a broadcasting context setup response message to CU-CP1, carrying the ID of the successfully established MRB.

When DU transmits a response message to a request message transmitted by an unselected service, that is, when DU transmits a broadcast context setup response message to CU-CP2, the response message may carry the MBS session ID (TMGI1 in this embodiment) selected by DU, the ID of MRB selected by DU, the MRB PDCP configuration selected by DU, and/or the indication that the F1 user plane is not established.

When CU-CP2 receives a response message carrying the MBS session ID selected by DU, or the ID of MRB, or the PDCP configuration selected by DU, and/or an indication indicating that the F1 user plane is not established, CU-CP2 knows that DU is shared, DU selects another MBS session, and the F1 user plane is not established. The PDCP configuration selected by DU is stored to be used next time when configuring the MBS radio data bearer of the TMGI2 to ensure the continuity of the data transmission of the new radio. CU-CP2 transmits a message from E1 to CU-UP (CU-UP2) controlled by CU-CP2. The message may be an MBS bearer context setup request or an MBS bearer context modification request. The message includes an indication indicating that DU does not establish an F1 user plane.

Afterwards, if DU needs to establish a user plane with CU-UP2, DU transmits a message to CU-CP2 for MBS service modification. The message includes indications indicating that there is an error in the current F1 user plane, or that an F1 user plane needs to be established with CU-CP2 or CU-UP2. The message further includes downlink receiving address assigned to TMGI2 by DU, the receiving address includes IP address of DU and tunnel ID TEID assigned by DU. The message may further include the service ID TMGI2 of MBS, the F1 interface ID assigned to TMGI2 by DU, the PDCP configuration and/or the highest PDCP sequence number that has been successfully transmitted, or the PDCP sequence number corresponding to the next data packet to be transmitted. The PDCP configuration is the PDCP configuration recommended by DU to CU-CP2, the PDCP configuration may be the same as the current PDCP configuration, which can reduce the need for DU to build new tunnels, data interruption and loss caused by different PDCP configurations.

By receiving the MBS service modification request message, CU-CP2 can transmit MBS bearer context setup request or MBS bearer context modification request to CU-UP2, carrying the downlink receiving address assigned to TMGI2 by DU, PDCP configuration information, the highest PDCP sequence number that has been successfully transmitted, or the PDCP sequence number corresponding to the next data packet to be transmitted to CU-UP2. By receiving the message, CU-UP2 uses the PDCP configuration information to transmit data to the downlink receiving address assigned by DU based on the PDCP sequence number.

In step 603, CU-CP transmits another broadcast context setup or modification request message to DU.

The message includes the F1 interface ID assigned to TMGI2 by CU-CP, the MBS session ID TMGI2, the ID associated with MBS, the MBS service coverage, and the message further includes MBS CU to DU RRC information. The MBS CU to DU RRC information includes the list of cells of TMGI2 and the list of adjacent cells broadcasting the MBS service. The MBS CU to DU RRC information further includes the MRB PDCP configuration. The broadcast context setup request message further includes information about the MBS radio bearer to be established, such as the ID of the MRB, the quality requirements of the MRB, the ID of the QoS flow mapped to the MRB, and the QoS requirement of the QoS flow. Broadcast is carried on the transport layer address of CU-UP. The message further includes an indication indicating whether there is MBS data transmission on the F1 user plane. In this embodiment, the indication is set to no data transmission.

If CU-CP receives a broadcast session setup request from TMGI2 and knows that TMGI1 and TMGI2 transmits the same MBS data through the same ID associated with MBS included in the session setup request message, CU-CP may decide not to establish a user plane with the core network for TMGI2. CU-CP further needs to decide whether to establish a user plane for the F1 interface with UD for TMGI2.

If it is decided to establish: in one method, the relevant information of TMGI2 and TMGI1 is transmitted through different F1 control signalling, and CU-CP transmits broadcast context setup request message to DU. The message includes the F1 interface ID assigned to TMGI2 by CU-CP, the MBS session ID TMGI2, the ID associated with MBS, the MBS service coverage, and MBS CU to DU RRC information. The MBS CU to DU RRC information includes the list of cells of TMGI2 and the list of adjacent cells broadcasting the MBS service. The MBS CU to DU RRC information further includes the MRB PDCP configuration. The broadcast service context setup request message further includes information about the MBS radio bearer to be established, such as the ID of the MRB, the quality requirements of the MRB, the ID of the QoS flow mapped to the MRB, and the QoS requirement of the QoS flow. Broadcast is carried on the transport layer address of CU-UP. DU transmits a response message to CU-CP, the message includes the F1 interface ID assigned to TMGI2 by DU, the MBS session ID TMGI2, the ID of the successfully established MRB, and the transport layer address information of the F1 user plane assigned to TMGI2 by DU. The F1 user plane transport layer address assigned to TMGI2 by DU may be same as or different from the F1 user plane transport layer address assigned to TMGI1 by DU. If they are same, the F1 user plane of TMGI2 and TMGI1 use the same tunnel. If they are different, the F1 user plane of TMGI2 and TMGI1 use different tunnels.

In another method, the relevant information of TMGI2 and TMGI1 is transmitted through the same F1 control signalling, and CU-CP transmits a broadcast context modification request message to DU. The message includes the F1 interface ID assigned to TMGI1 by CU-CP, the MBS session ID TMGI1, the ID associated with MBS, the MBS session ID TMGI2, and the MBS CU to DU RRC information. The MBS CU to DU RRC information includes the list of cells of TMGI2 and the list of the adjacent cells broadcasting the MBS service. The MBS CU to DU RRC information further includes the MRB PDCP configuration. The message may include multiple CU to DU RRC information, including TMGI1 and TMGI2 information respectively. DU transmits a response message to CU-CP, the message includes the F1 interface ID assigned to TMGI1 by DU, the MBS session ID TMGI1.

If it is decided not to establish: in one method, the relevant information of TMGI2 and TMGI1 is transmitted through different F1 control signalling. CU-CP decides not to establish the F1 user plane of TMGI2 temporarily, but needs to transmit the information of TMGI2 to DU, so that CU-CP transmits broadcast context setup request message to DU. The message includes the F1 interface ID assigned to TMGI2 by CU-CP, the MBS session ID TMGI2, the ID associated with MBS, the MBS CU to DU RRC information, the MBS session ID TMGI1 associated with TMGI2, and an indication indicating that DU does not need to assign an F1 tunnel. DU transmits a response message to CU-CP, the message includes the F1 interface ID assigned to TMGI2 by DU, the MBS session ID TMGI2.

In another method, the relevant information of TMGI2 and TMGI1 is transmitted through the same F1 control signalling. CU-CP decides not to establish the F1 user plane of TMGI2 temporarily, but needs to transmit the information of TMGI2 to DU. Therefore, CU-CP transmits broadcast context modification request message to DU. The message includes the F1 interface ID assigned to TMGI1 by CU-CP, the MBS session ID TMGI1, the ID associated with MBS, and the MBS session ID TMGI2. The message further includes the MBS CU to DU RRC information, the MBS CU to DU RRC information includes the list of cells of TMGI2 and the list of the adjacent cells broadcasting the MBS service, and includes an indication indicating that DU does not need to assign an F1 tunnel to TMGI2. DU transmits a response message to CU-CP, the message includes the F1 interface ID assigned to TMGI1 by DU and the MBS session ID TMGI1.

Step 604, DU transmits a broadcast context setup response or modification response message to CU-CP.

The message may include the F1 interface ID assigned to TMGI2 by DU, the F1 interface ID assigned to TMGI1 by DU, the MBS session ID TMGI2, the MBS session ID TMGI1, the ID associated with MBS, the ID of the successfully established MRB, the transport layer address information of the F1 user plane assigned to TMGI2 by DU, and the transport layer address information of the F1 user plane assigned to TMGI1 by DU. If in steps 601 and 603, CU-CP transmitting the message of step 601 and CU-CP transmitting the message of step 603 are the same entity, the same entity may assign the same MRB and MRB configuration information to TMGI1 and TMGI2.

If in steps 601 and 603, CU-CP transmitting the message of step 601 and CU-CP transmitting the message of step 603 are different entities, that is, DU receives broadcast context setup request messages from different CU-CPs, and the MRBs included in the two messages are different, and the MRB configurations are different, DU selects one of the MRBs and MRB configurations, and uses the selected MRB and MRB configuration when broadcasting MBS data on the new radio. DU may include the MRB and MRB configuration selected by DU in the broadcast context setup response and transmit the same to CU-CP. CU-CP can further transmit the MRB and MRB configuration information to CU-UP. CU-UP may reconfigure the corresponding MRB and MRB configurations.

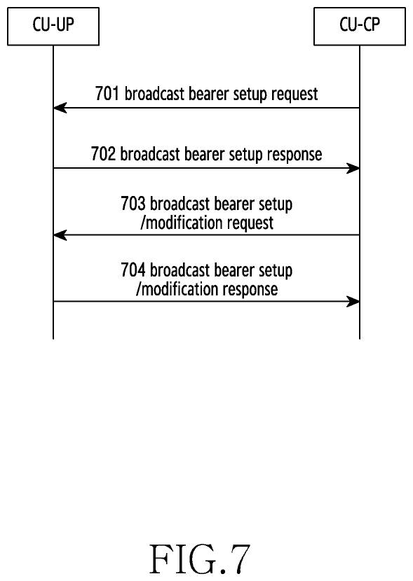

FIG. 7 depicts the procedure of establishing E1 according to an embodiment of the disclosure.

TMGI1 and TMGI2 are for the same MBS service. CU-CP determines whether to establish an F1 user plane on F1 to transmit MBS data. When CU-CP decides not to establish an NG interface user plane, CU-CP may also decide not to establish an F1 interface user plane.

In step 701, CU-CP transmits a broadcast bearer setup request message to CU-UP.

The message includes the E1 interface ID assigned to TMGI1 by CU-CP, the MBS session ID TMGI1, the ID associated with MBS, the MBS service coverage. The broadcast bearer setup request message further includes information about the MBS radio bearer to be established, such as the ID of MRB, quality requirement of MRB, QoS flow ID mapped to the MRB, and QoS requirement of QoS flow.

In step 702, CU-UP transmits a broadcast bearer setup response message to CU-CP.

The message includes the E1 interface ID assigned to TMGI1 by CU-UP, the MBS session ID TMGI1, the ID associated with MBS, the ID of the successfully established MRB, and the transport layer address information of the F1 user plane assigned to TMGI1 by CU-UP.

In step 703, CU-CP transmits another broadcast bearer setup request or broadcast bearer modification request message to DU.

If CU-CP receives the broadcast session setup request from TMGI1 and knows that TMGI1 and TMGI2 transmits the same MBS data through the same ID associated with MBS included in the session setup request message, CU-CP decides not to establish a user plane with the core network for TMGI2. Then CU-CP also needs to decide whether to establish a user plane for the F1 interface between CU-UP and DU for TMGI2.

If it is decided to establish: in one method, the relevant information of TMGI2 and TMGI1 is transmitted through different E1 control signalling, and CU-CP transmits a broadcast bearer setup request message to DU. The message includes the E1 interface ID assigned to TMGI2 by CU-CP, the MBS session ID TMGI2, the ID associated with MBS, the MBS service coverage, and MRB PDCP configuration. The broadcast bearer setup request message further includes information about the MBS radio bearer to be established, such as the ID of the MRB, the quality requirements of the MRB, the ID of the QoS flow mapped to the MRB, and the QoS requirement of the QoS flow. CU-UP transmits a response message to CU-CP, the message includes the F1 interface ID assigned to TMGI2 by CU-UP, the MBS session ID TMGI2, the ID of the successfully established MRB, and the transport layer address information of the F1 user plane assigned to TMGI2 by DU.

In another method, the relevant information of TMGI2 and TMGI1 is transmitted through the same E1 control signalling, and CU-CP transmits a broadcast bearer modification request message to CU-UP. The message includes the E1 interface ID assigned to TMGI1 by CU-CP, the MBS session ID TMGI1, the ID associated with MBS, the MBS session ID TMGI2, and the MRB PDCP configuration. CU-UP transmits a response message to CU-CP, the message includes the E1 interface ID assigned to TMGI1 by CU-UP, the MBS session ID TMGI1.

If it is decided not to establish: in one method, the relevant information of TMGI2 and TMGI1 is transmitted through different E1 control signalling. CU-CP decides not to establish the F1 user plane of TMGI2 temporarily but needs to transmit the information of TMGI2 to CU-UP, CU-UP transmits a broadcast bearer setup request message to CU-UP. The message includes the E1 interface ID assigned to TMGI2 by CU-CP, the MBS session ID TMGI2, the ID associated with MBS, the MBS session ID TMGI1 associated with TMGI2, and an indication indicating that CU-UP does not need to assign an F1 tunnel. CU-UP transmits the corresponding message to CU-CP, the message includes the E1 interface ID assigned to TMGI2 by CU-UP, the MBS session ID TMGI2.

The relevant information of TMGI2 and TMGI1 is transmitted through the same E1 control signalling. CU-CP decides not to establish the F1 user plane of TMGI2 temporarily but needs to transmit the information of TMGI2 to CU-UP, CU-UP transmits a broadcast bearer modification request message to DU. The message includes the E1 interface ID assigned to TMGI1 by CU-CP, the MBS session ID TMGI1, the ID associated with MBS, the MBS session ID TMGI2, and the indication indicating that CU-UP does not need to assign an F1 tunnel. CU-UP transmits the corresponding message to CU-CP, the message includes the E1 interface ID assigned to TMGI1 by CU-UP, the MBS session ID TMGI1.

In step 704, CU-UP transmits a broadcast bearer setup response or modification response message to CU-CP.

The message may include the F1 interface ID assigned to TMGI2 by CU-UP, the F1 interface ID assigned to TMGI1 by CU-UP, the MBS session ID TMGI2, the MBS session ID TMGI1, the ID associated with MBS, the ID of the successfully established MRB, the transport layer address information of the F1 user plane assigned to TMGI2 by CU-UP, and the transport layer address information of the F1 user plane assigned to TMGI1 by CU-UP. If in steps 701 and 703, CU-CP transmitting the message of step 701 and CU-CP transmitting the message of step 703 are the same entity, the same entity may assign the same MRB and MRB configuration information to TMGI1 and TMGI2.

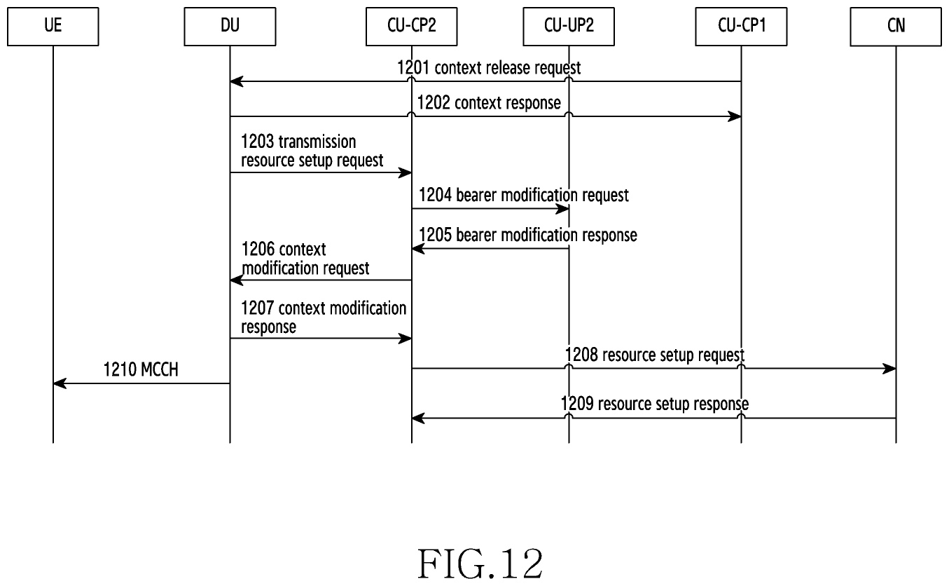

FIG. 12 depicts the procedure of establishing the F1 tunnel according to an embodiment of the disclosure.

TMGI1 and TMGI2 are for the same MBS service, that is, the transmitted data are the same, but they belong to operators PLMN1 and PLMN2 respectively. In this embodiment, DU is shared by PLMN1 and PLMN2, and the CU part is not shared. PLMN1 controls CU-CP1 and CU-UP1, and PLMN2 controls CU-CP2 and CU-UP2. Only one F1 tunnel is established on F1, for example, only the F1 tunnel between DU and CU-UP1 is established, and MBS data is transmitted to DU through the tunnel. On the air, DU broadcasts the MRB configuration information corresponding to TMGI1 and MRB configuration information corresponding to TMGI2, MRB configuration information includes configuration information of PDCP, configuration information of RLC, configuration information of MAC layer and configuration information of physical layer. In order to save resources, the MRB configuration information broadcasted in the air is the same for TMGI1 and TMGI2, and only one data is transmitted in the air. When the service of TMGI1 ends in advance, the F1 tunnel between DU and CU-UP1 also needs to be deleted. At this time, if TMGI2 has not ended, DU needs to initiate the establishment of F1 tunnel with CU-UP2. During the switch of the F1 tunnel, there may be data loss. FIG. 12 describes the process of establishing F1 tunnel initiated by DU. Through this method, it can be guaranteed that UE can continuously receive MBS services when the F1 tunnel is switched, and data will not be lost due to the F1 tunnel switching.

In step 1202: CU-CP1 transmits a context release command to DU.

The context release request message is for TMGI1, that is, the message includes the MBS service ID TMGI1 or includes the ID of TMGI1 at the F1 interface.

After DU receives the MBS context release command message transmitted by CU-CP1, DU deletes the context related to TMGI1. In the air, DU needs to stop broadcasting the related information of TMGI1 on the MBS control channel MCCH, and at the beginning of the next latest modification period, DU stops broadcasting the MRB configuration information of TMGI1 on MCCH.

At this time, TMGI2 is not ended yet, and the UE needs to receive the data of TMGI2. In order to ensure that UE interested in TMGI2 can continue to receive MBS services, DU needs to transmit a request message to CU-CP2 requesting to establish an F1 tunnel with CU-UP2, and use the tunnel to transmit TMGI2 data. In this step, the message indicates that the F1 tunnel is to be established, and the message carries the service ID TMGI2 or the ID of TMGI2 at the F1 interface. The message can also carry the transport layer address information of the F1 tunnel allocated for TMGI2 by DU, and the transport layer address information includes the IP address, tunnel ID and other information.

In the air, before TMGI1 is released, the MRB configuration information corresponding to TMGI1 and MRB configuration information corresponding to TMGI2 are broadcasted on MCCH, and their corresponding MRB configuration information is the same. For the UE to receive TMGI2 data, it configures PDCP protocol layer and RLC layer according to the MRB configuration information. MBS data transmission is from the core network of PLMN1 to CU-UP1, and then transmitted to DU through F1 tunnel between CU-UP1 and DU, and then transmitted to UE. The PDCP of UE receives MBS data based on the mechanism of receiving window. If the sequence number of PDCP of MBS data is out of the receiving window, UE needs to discard the data. The parameters related to PDCP reception of UE are set to initial values when the PDCP protocol layer of CU-UP1 and UE is established. As sequence number of PDCP allocated by CU-UP1 increases, the parameters related to PDCP reception of UE are also changing. When the sequence number carried by the PDCP packet meets a certain condition, the UE considers that the PDCP packet is legal and can proceed to the next step, otherwise, the UE considers that the PDCP packet needs to be discarded. That is, the determination of whether to discard the PDCP packet is based the sequence number carried by the PDCP packet and the parameters related PDCP reception at the receiving end. When the F1 tunnel is re-established between DU and CU-UP2, the PDCP protocol on CU-UP2 is newly established. When the PDCP protocol allocates sequence number to data, the sequence number is allocated from the initial value of PDCP SN, which is generally equal to zero or 1. According to the sequence number of PDCP packet processed by PDCP of CU-UP2, while the parameters related to PDCP reception at UE end are calculated according to PDCP between CU-UP1, the sequence number of PDCP packet transmitted by CU-UP2 is probably out of the PDCP receiving window of UE, and according to the decision conditions, DU will discard the packets transmitted by CU-UP2, which will cause UE to discard the data transmitted by CU-UP2.

In order to solve this problem, one method (the first method) is that when CU-CP1 transmits a context release command to DU, the message carries the MBS service ID TMGI1 or the ID of TMGI1 in F1 interface, and the message also includes the status information of MBS radio bearer MRB, in which the status information of MRB includes the ID of MRB, the Count Value information corresponding to MRB, or the Hyper Frame Number HFN information corresponding to MRB, and may also include the PDCP information corresponding to MRB. The information can be transmitted to DU as a container or a separate information element. If transmitted as a container, DU does not need to parse it. Among them, the Count Value information includes the sequence number of HFN and PDCP. The status information of MRB is obtained by CU-CP1 from CU-UP1, that is, when CU-CP1 transmits the bearer release request message, it indicates CU-UP1 to carry the status information of MRB in the bearer release response message, and then CU-UP1 transmits the status information of MRB to CU-CP1 through the bearer release response message. Alternatively, CU-CP1 does not need indications, and CU-UP1 carries the status information of MRB in the bearer release response message.

In step 1202: DU transmits a context release complete message to CU-CP1.

DU transmits a response message for the releasement to CU-CP1.

In step 1203: DU transmits a transmission resource setup request message to CU-CP2.

In order to solve the above-mentioned problem that the data received from the new tunnel will be outside the receiving window of the UE and thereby will be discarded when the F1 tunnel is switched, in the first method, when DU transmits the F1 transmission resource setup request message to CU-CP2, the message carries the ID of TMGI2 or the ID of TMGI2 at the F1 interface, and the message carries the MRB status information, which DU received from CU-CP1. As mentioned above, this information can be a container that DU forwards the same to CU-CP2 in step 1203. Or when DU transmits a message to CU-CP2, the message also carries the ID of MRB, the HFN information received by DU from CU-CP1, and the PDCP configuration information, which is the PDCP configuration information selected for TMGI1 and TMGI2 by DU and broadcasted in the air, and the message also carries the information related to the sequence number of PDCP, which is described above.

In the second method, DU does not need to obtain the MRB status information related to TMGI1 from CU-CP1, DU can transmit the information stored on DU to CU-CP2, so that the sequence numbers of PDCP packets sent by CU-UP2 and CU-UP1 are continuous. When DU transmits the F1 transmission resource setup request message to CU-CP2, the message carries the ID of TMGI2 or the ID of TMGI2 at F1 interface, and the message also carries the information of MRB, which includes the ID of MRB and PDCP configuration information, which is the PDCP configuration information selected for TMGI2 by DU and broadcasted in the air, and the message also carries the information related to sequence number of PDCP. As shown in step 602, the information related to sequence number of PDCP is the highest sequence number of PDCP that has been successfully transmitted, or the sequence number of PDCP corresponding to data packet to be transmitted next, or recommended sequence number of PDCP to CU-CP2.

CU-CP2 transmits PDCP configuration information, Count value or information related to sequence number of PDCP to CU-UP2 through E1 message. CU-UP2 uses the configuration to configure the PDCP protocol. By this method, CU-UP2 and CU-UP1 use the same PDCP configuration, and the sequence numbers of PDCP are also related, for example, continuous, thus ensuring that the data packets transmitted by CU-UP2 can meet the conditions of correct reception by the UE, and the data packets transmitted by CU-UP2 will not be discarded.

In step 1204: CU-CP2 transmits an MBS bearer setup or modification request message to CU-UP2.

The message carries the ID of TMGI2 or TMGI2 at E1 interface, includes the PDCP configuration information, and also includes the information related to Count value or sequence number of PDCP. If the NG-U tunnel between CU-UP2 and the core network is not established for TMGI2, the message can also carry the indication of NG-U setup or the indication of allocating NG-U resources.

In step 1205: CU-UP2 transmits an MBS bearer setup or modification response message to CU-CP2.

CU-UP2 establishes the resources carried by MBS and allocates the transport layer address of F1 tunnel, and transmits the transport layer address of the F1 tunnel to CU-CP2 through a response message. If the NG-U tunnel between CU-UP2 and the core network is not established for TMGI2, or according to the indication carried by 1003, CU-UP2 allocates the transport layer address of NG-U, and includes the address information in the response message and transmits it to CU-CP2.

In step 1206: CU-CP2 transmits a context modification request message to DU.

The message carries TMGI2, the ID of TMGI2 at F1 interface, and the transport layer address of F1 tunnel allocated by CU-UP2.

In step 1207: DU transmits a context modification response message to CU-CP2.

DU transmits a message to confirm the reception of the message. If the transport layer address of the F1 tunnel allocated by DU is not carried in step 1201, the transport layer address of the F1 tunnel allocated by DU can be included in this step.

DU needs to broadcast the MRB configuration information of TMGI2 on the MCCH channel in the air. In order to solve the problem mentioned above, a third method is to indicate UE to re-establish the PDCP protocol stack and reset the parameters related to PDCP reception to the initial values. CU-CP2 does not need to know the PDCP configuration selected by DU and the sequence number of PDCP and HFN of CU-UP1. CU-CP2 itself decides the PDCP configuration used by CU-UP2, establishes the PDCP protocol and calculates the sequence number of PDCP according to the existing method.

After receiving the service release request transmitted by CU-CP1, from an appropriate point of time, for example, from the beginning of next modification period, DU will not broadcast the MRB configuration information of TMGI1 on the MCCH channel. In step 1210, the DU broadcasts the MRB configuration information to the UE. For the first method and the second method, the PDCP configuration information corresponding to TMGI2 is not changed, so the MRB configuration information broadcasted by the DU is not changed either. For the third method, the MRB configuration information of TMGI2, the PDCP configuration information broadcasted by DU is the PDCP configuration information received from CU-CP2 by DU, and the MRB configuration information of TMGI2 broadcasted by DU also includes the indication of PDCP re-establishment. For example, it is set to 1 to indicate that the UE needs to reset the PDCP protocol stack.

UE receives the indication of PDCP re-establishment broadcasted on MCCH, and expects to re-establish PDCP, including the operations of re-establishing PDCP by adopting the received new PDCP configuration parameters and/or setting all parameters related to PDCP reception to initial values.

When the PDCP of CU-UP2 transmits data, under the first method and the second method, the same PDCP configuration and continuous sequence numbers of PDCP as that of CU-UP1 are adopted, so that the data packet transmitted by CU-UP2 falls within the PDCP receiving window of UE, guaranteeing that the data can be correctly received and reducing data loss.

When the PDCP of CU-UP2 transmits data, under the third method, the PDCP protocol starts to calculate the sequence number of PDCP from the initial value, and the UE also re-establishes the PDCP protocol and starts to calculate the sequence number of PDCP from the initial value, so that the data packet transmitted by CU-UP2 falls within the PDCP receiving window of the UE, guaranteeing that the data can be correctly received and reducing data loss.

In step 1208: CU-CP2 transmits a message to the core network.

If the NG-U tunnel between CU-UP2 and the core network is not established, CU-CP2 also needs to transmit a message to the core network requesting the establishment of the NG-U tunnel. The message includes TMGI2 and the transport layer address of NG-U allocated by CU-UP2.

In step 1209: The core network transmits a response message to CU-CP2.

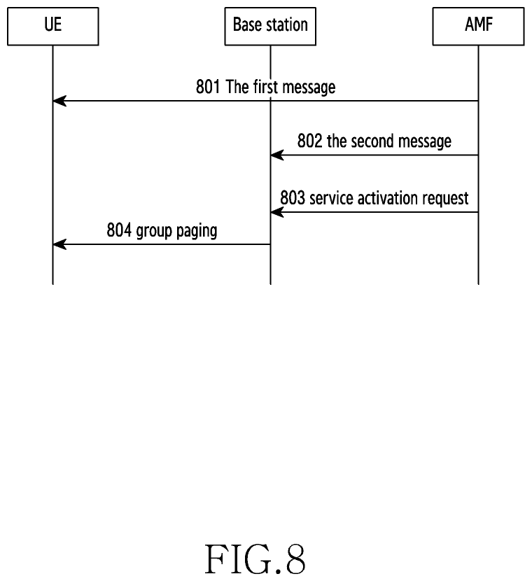

FIGS. 8, 9, and 10 describe an enhanced group paging scheme that ensures the UE can receive data with higher quality according to various embodiments of the disclosure.

FIG. 8 depicts that the network configures the UE to receive multicast service according to an embodiment of the disclosure.

The base station may decide whether the UE enters RRC inactive state to receive multicast service or maintains in RRC connected state to receive multicast service. When the multicast service is activated or the multicast service data is in activated state, MBS data is not transmitted temporarily. The base station configures the UE to enter RRC inactive state, and how to wake up the UE for receiving multicast service data when MBS data transmission is switched from stopped to started.

In step 801, the core network AMF transmits the first message to the UE. The first message is a non-access layer message, which includes the session ID TMGI of the multicast service. The message further includes an indication indicating that the UE expects to maintain in RRC connected mode to receive MBS service, or indicating the special characteristics or identity of the UE, or indicating that the UE expects to receive high-quality service to ensure stable and timely system resources for data transmission. According to the indication, the UE will maintain in RRC connected mode to receive MBS service. The UE stores TMGI and the indication, and can transmit the indication to access layer of UE for utilization.

In step 802, the core network transmits a second message to the base station. The second message is a message of the NG interface, which includes the session ID TMGI of the multicast service. The message further includes indication indicating that the UE expects to maintain in RRC connected mode to receive MBS service, or indicating the special characteristics or identity of the UE, or indicating that the UE expects to receive high-quality services to ensure stable and timely system resources for data transmission. The base station stores the indication in the context of the UE. The base station may decide to maintain the UE in RRC connected mode to receive MBS service based on the indication.

Afterwards, when there is no other unicast service to receive and the MBS service is not activated, the base station may configure the UE to enter RRC inactive mode, such as transmitting an RRC release request message to the UE and configuring the UE to enter RRC inactive mode. This step may be omitted.

In step 803, the core network transmits a multicast session activation request message to the base station. The message includes the session ID TMGI of multicast service.

In step 804, the base station transmits a group paging message to the UE.

The base station detects that the UE is in RRC inactive state or RRC idle state. The base station transmits a group paging message to wake up the UE. The group paging includes the session ID TMGI of multicast service, and an indication indicating the UE to receive MBS service while the UE maintains in RRC inactive state. If the UE supports receiving MBS service in RRC inactive state and does not receive the indication of step 801, the UE may maintain in RRC inactive state to receive multicast service.

If the UE supports receiving MBS services in RRC inactive state and receives the indication of step 801, the UE needs to transmit an RRC recovery request message requesting to enter RRC connected state to receive multicast service. Afterwards, through RRC recovery procedure, the UE enters RRC connected state to receive data of MBS service.

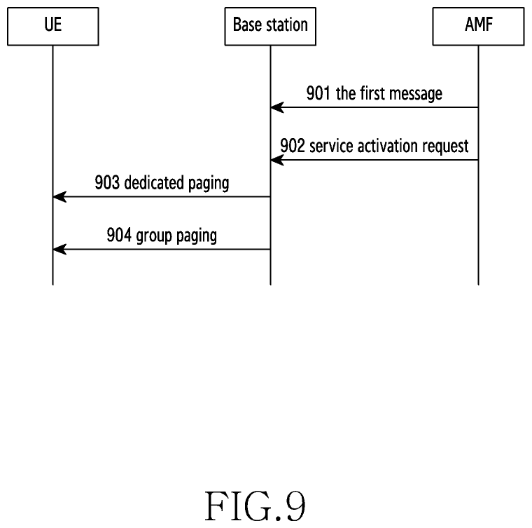

FIG. 9 depicts that the network configures the UE to receive multicast service according to an embodiment of the disclosure.

The base station may decide whether the UE enters RRC inactive state to receive multicast service or maintains in RRC connected state to receive multicast service. When multicast service is activated or multicast service data is in activated state, MBS data is not transmitted temporarily. The base station configures the UE to enter RRC inactive state, and how to wake up the UE for receiving multicast service data when MBS data transmission is switched from stopped to started.

In step 901, the core network transmits a first message to the base station. The first message is a message from the NG interface, which includes the session ID TMGI of multicast service. The message further includes an indication indicating that the UE expects to maintain in RRC connected mode to receive MBS service, or indicating the special characteristics or identity of the UE, or indicating that the UE expects to receive high-quality service to ensure stable and timely system resources for data transmission. The base station stores the indication in the context of the UE, the base station may decide to maintain the UE in RRC connected mode to receive MBS services based on the indication.

Afterwards, when there is no other unicast service to receive and the MBS service is not activated, the base station may configure the UE to enter RRC inactive mode, such as transmitting an RRC release request message to the UE and configuring the UE to enter RRC inactive mode. This step may be omitted.

In step 902, the core network transmits a multicast session activation request message to the base station. The message includes the session ID TMGI of multicast service.

In step 903, the base station transmits a dedicated paging request message to the UE.

Based on the stored UE context, if the UE applies to join the multicast session indicated by the TMGI, the UE is in RRC inactive state, and the indication described in step 901 is stored in the UE context. The base station decides that the UE maintains in RRC connected mode to receive MBS service. The base station should first initiate a dedicated paging request message to the UE. When the UE receives the dedicated paging request message, the UE initiates an RRC recovery request message requesting to enter RRC connected state to receive multicast service. Afterwards, through the RRC recovery procedure, the UE enters RRC connected state to receive MBS service data.

In step 904, the base station transmits a group paging message to the UE.

The base station detects that the UE is in RRC inactive state or RRC idle state. The base station transmits a group paging message to wake up the UE. The group paging includes the session ID TMGI of multicast service, and an indication indicating the UE to receive MBS service while the UE maintains in RRC inactive state. By receiving the group paging, if the UE supports receiving MBS service in RRC inactive state, the UE maintains in RRC inactive state to receive multicast service. Otherwise, the UE needs to transmit an RRC recovery request message requesting to enter RRC connected state to receive multicast service. Afterwards, through the RRC recovery procedure, the UE enters RRC connected state to receive MBS service data.

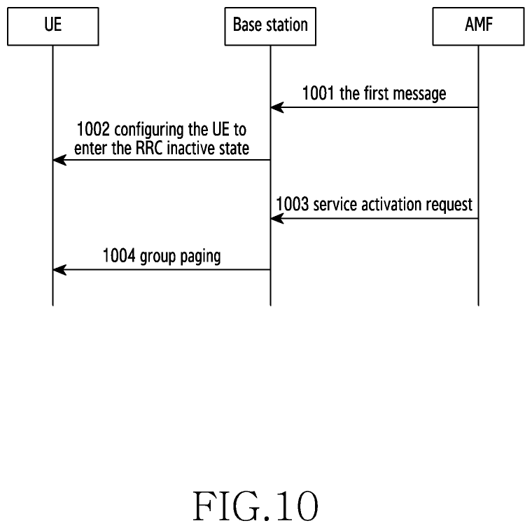

FIG. 10 depicts that the network configures the UE to receive multicast service according to an embodiment of the disclosure.

The base station may decide whether the UE enters RRC inactive state to receive multicast service or maintains in RRC connected state to receive multicast service. When multicast service is activated or multicast data is in activated state, MBS data is not transmitted temporarily. The base station configures UE to enter RRC inactive state, and how to wake up the UE for receiving multicast service data when MBS data transmission is switched from stopped to started.

In step 1001, the core network transmits a first message to the base station. The first message is a message from the NG interface, which includes the session ID TMGI of multicast service. The message further includes an indication indicating that the UE expects to maintain in RRC connected mode to receive MBS services or indicating the special characteristics or identity of the UE, or indicating that the UE expects to receive high-quality services to ensure stable and timely system resources for data transmission. The base station stores the indication in the context of the UE, the base station may decide to maintain UE in RRC connected mode to receive MBS service based on the indication.

In step 1002, the base station transmits a second message to the UE to configuring the UE to enter RRC inactive state.

When there is no other unicast service to receive and MBS service has no data to be received, the base station may configure the UE to enter RRC inactive mode, such as transmitting an RRC release request message to the UE and configuring the UE to enter RRC inactive mode. The second message further includes the session ID TMGI of the multicast service, and an indication indicating that the UE expects to maintain in RRC connected mode to receive MBS service, or indicating the special characteristics or identity of the UE, or indicating that the UE expects to receive high-quality services to ensure stable and timely use of system resources for data transmission, or indicating that the base station decides that the UE maintains in RRC connected mode to receive MBS service.

In step 1003, the core network transmits a multicast session activation request message to the base station. The message includes the session ID TMGI of multicast service.

Alternatively, in step 1003, the base station receives MBS data from the core network user plane.

If the base station is a separate architecture, CU-UP receives data from the core network user plane, and CU-UP transmits a message to inform CU-CP that there is MBS data to be transmitted. The base station can perform the following steps, such as transmitting a group paging message to the UE.

In step 1004, the base station transmits a group paging message to the UE.

The base station detects that the UE is in RRC inactive state or RRC idle state. The base station transmits a group paging message to wake up the UE. The group paging includes the session ID TMGI of multicast service, and an indication indicating the UE to receive MBS services while the UE maintains in RRC inactive state. If the UE supports receiving MBS services in RRC inactive state and does not receive the indication of step 1002, the UE may maintain in RRC inactive state to receive multicast service.

If UE supports receiving MBS services in RRC inactive state and receives the indication from step 1002, the UE needs to transmit an RRC recovery request message requesting to enter RRC connected state to receive multicast service. Afterwards, through the RRC recovery procedure, the UE enters RRC connected state to receive data from MBS service.

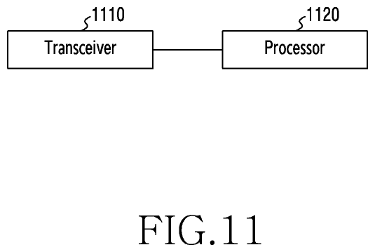

FIG. 11 is a block diagram of a communication device according to an embodiment of the disclosure.

The communication device may be used to implement the user equipment, the first base station, the second base station, DU of the first or second base station, CU of the first or second base station, CU-UP of the first or second base station, CU-CP of the first or second base station, etc. disclosed in the disclosure.

Referring to FIG. 11, the communication device according to the disclosure includes a transceiver 1110 and a processor 1120. The transceiver 1110 and processor 1120 are configured to perform various embodiments of the disclosure. Although transceiver 1110 and processor 1120 are shown as separate entities, they may be implemented as individual entities, such as a single chip. The transceiver 1110 and processor 1120 may be electrically connected or coupled to each other. The transceiver 1110 can transmit signals to other network devices and receive signals from other network entities, other network devices such as UE, base stations, or core network nodes. The processor 1120 may include one or more processing units and may control the network devices to perform operations and/or functions according to at least one of the aforementioned embodiments.

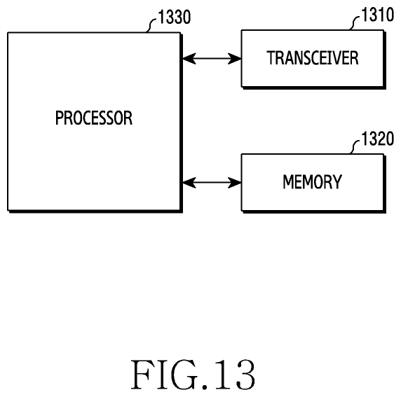

FIG. 13 illustrates a block diagram illustrating a structure of a UE according to an embodiment of the disclosure.

Referring to FIG. 13, the UE according to an embodiment may include a transceiver 1310, memory 1320, and a processor 1330. The transceiver 1310, the memory 1320, and the processor 1330 of the UE may operate according to a communication method of the UE described above. However, the components of the UE are not limited thereto. For example, the UE may include more or fewer components than those described above. In addition, the processor 1330, the transceiver 1310, and the memory 1320 may be implemented as a single chip. Also, the processor 1330 may include at least one processor.

The transceiver 1310 collectively refers to a UE receiver and a UE transmitter, and may transmit/receive a signal to/from a base station or a network entity. The signal transmitted or received to or from the base station or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the UE. Also, the memory 1320 may store control information or data included in a signal obtained by the UE. The memory 1320 may be a storage medium, such as read-only memory (ROM), random access memory (RAM), a hard disk, a compact disc read only memory (CD-ROM), and a digital versatile disc (DVD), or a combination of storage media.

The processor 1330 may control a series of processes such that the UE operates as described above. For example, the transceiver 1310 may receive a data signal including a control signal transmitted by the base station or the network entity, and the processor 1330 may determine a result of receiving the control signal and the data signal transmitted by the base station or the network entity.

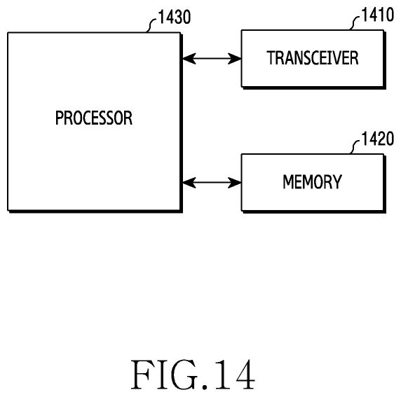

FIG. 14 illustrates a block diagram illustrating a structure of a base station or core network entity according to an embodiment of the disclosure.

Referring to FIG. 14, the base station according to an embodiment may include a transceiver 1410, memory 1420, and a processor 1430. The transceiver 1410, the memory 1420, and the processor 1430 of the base station may operate according to a communication method of the base station described above. However, the components of the base station are not limited thereto. For example, the base station may include more or fewer components than those described above. In addition, the processor 1430, the transceiver 1410, and the memory 1420 may be implemented as a single chip. Also, the processor 1430 may include at least one processor.

The transceiver 1410 collectively refers to a base station receiver and a base station transmitter, and may transmit/receive a signal to/from a terminal or a network entity. The signal transmitted or received to or from the terminal or a network entity may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the base station. Also, the memory 1420 may store control information or data included in a signal obtained by the base station. The memory 1420 may be a storage medium, such as read-only memory (ROM), random access memory (RAM), a hard disk, a CD-ROM, and a DVD, or a combination of storage media.

The processor 1430 may control a series of processes such that the base station operates as described above. For example, the transceiver 1410 may receive a data signal including a control signal transmitted by the terminal, and the processor 1430 may determine a result of receiving the control signal and the data signal transmitted by the terminal.

According to the disclosed embodiments, a user equipment (UE) may also be provided, the UE includes a transceiver; and a processor coupled to the transceiver and configured to perform the method performed by the UE in the communication system as described above, in other words, configured to perform the operations performed by the UE as described above with reference to any one of FIGS. 8 to 10. For details of the above operations, please refer to the description of any one of FIGS. 8 to 10, which will not be repeated.

According to the disclosed embodiments, an electronic device may also be provided, the electronic device includes at least one processor; and at least one memory storing computer executable instructions, wherein the computer executable instructions cause the at least one processor to perform as described in any of the above methods when executed by the at least one processor.

As an example, electronic devices may be PC computers, tablet devices, personal digital assistants, smartphones, or other devices capable of executing the aforementioned set of instructions. Herein, the electronic device does not have to a single electronic devices, but can also be a collection of devices or circuits that can execute the above instructions (or set of instructions) individually or jointly. The electronic device may also be part of an integrated control system or system manager or may be configured as portable electronic device that interfaces with each other locally or remotely (for example, via wireless transmission).

In the electronic device, the processor can include a central processing unit (CPU), a graphics processing unit (GPU), a programmable logic device, a specialized processor system, a microcontroller, or a microprocessor. As an example rather than a limitation, processor may also include an analog processor, a digital processor, a microprocessor, a multi-core processor, a processor array, a network processor, etc.

The processor can execute instructions or code stored in memory, where the memory may also store data. Instructions and data may also be transmitted and received through the network via network interface device that can use any known transmission protocols.

The memory may be integrated with the processor, for example, by placing RAM or flash memory within integrated circuit microprocessor, etc. In addition, the memory may include independent device, such as external disk driver, storage array, or other storage device that may be used by any database system. The memory and the processor may be coupled operationally, or they can communicate with each other, such as through input/output (I/O) ports, network connections, etc., so that the processor can read files stored in the memory.

In addition, the electronic device may also include a video display (such as liquid crystal display (LCD) displays) and a user interaction interface (such as a keyboard, a mouse, a touch input device, etc.). All components of the electronic device may be connected to each other through buses and/or networks.

According to the embodiments of the disclosure, a computer-readable storage medium for storing instructions may also be provided, wherein when the instructions executed by at least one processor, the at least one processor can perform any of the above methods according to the example embodiments of the disclosure. Examples of computer-readable storage media herein include: read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW DVD+RW, DVD-RAM, BD-ROM, BD-R, BD-R LTH, BD-RE, Blu ray or optical memory, Hard Disk Drive (HDD), Solid State Hard Disk (SSD), Card memory (such as multimedia cards, Secure Digital (SD) cards, or Extreme Digital (XD) cards), magnetic tapes, floppy disks, magneto-optical data storage devices, optical data storage devices, hard disks, solid-state disks, and any other devices, configured to store computer programs and any associated data, data files, and data structures in a non-temporary manner and provide the computer program and any associated data, data files, and data structures to the processor or computer to enable the processor or computer to perform the computer program. The instructions or computer programs in the above-mentioned computer-readable storage medium can be executed in environments deployed in computer devices such as clients, hosts, proxy devices, servers, etc. In addition, in an example, the computer program and any associated data, data files, and data structures are distributed on networked computer systems, such that the computer program and any associated data, data files and data structures are stored, accessed, and performed in a distributed manner through one or more processors or computers.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first node in a wireless communication system, the method comprising:
determining whether to establish an F1 tunnel with a third node;
transmitting, to a second node, a first message including a first indication, wherein the first indication indicates that a user plane between the third node and the first node has not been established; and
transmitting, to the third node, a second message including a second indication, wherein the second indication indicates that the user plane between the third node and the first node has not been established.

2. The method of claim 1, further comprising:
receiving, from a fourth node, a fourth message including at least one of:
an identification (ID) of a multicast radio bearer (MRB) and information configuring a packet data convergence protocol (PDCP),
a count value, or
information related sequence number of the PDCP.

3. The method of claim 2, wherein the fourth message is obtained from the user plane.

4. The method of claim 1, further comprising:
transmitting, to the second node, a third message including transport layer address information of the F1 tunnel.

5. The method of claim 1, further comprising:
transmitting, to the second node, a third message including at least one:
an ID of an MRB,
information configuring a PDCP,
a hyper frame number (HFN),
a count value, or
information related sequence number of the PDCP.

6. The method of claim 5, wherein the information related to sequence number of the PDCP is a highest sequence number of the PDCP that has been successfully transmitted, a sequence number of the PDCP corresponding to a data packet to be transmitted next, or a recommended sequence number of the PDCP.

7. The method of claim 1, further comprising:
broadcasting an identification of a multimedia broadcast service (MBS) service, information configuring a PDCP, and a PDCP re-establishment indication.

8. A first node in a wireless communication system, the first node comprising:
a transceiver; and
a controller coupled to the transceiver, and configured to:
determine whether to establish an F1 tunnel with a third node,
transmit, to a second node, a first message including a first indication, wherein the first indication indicates that a user plane between the third node and the first node has not been established, and
transmit, to the third node, a second message including a second indication, wherein the second indication indicates that the user plane between the third node and the first node has not been established.

9. The first node of claim 8, wherein the controller is further configured to:
receive, from a fourth node, a fourth message including at least one of:
an identification (ID) of a multicast radio bearer (MRB) and information configuring a packet data convergence protocol (PDCP),
a count value, or
information related sequence number of the PDCP.

10. The first node of claim 9, wherein the fourth message is obtained from the user plane.

11. The first node of claim 8, wherein the controller is further configured to:
transmit, to the second node, a third message including transport layer address information of the F1 tunnel.

12. The first node of claim 8, wherein the controller is further configured to:
transmit, to the second node, a third message including at least one:
an ID of an MRB,
information configuring a PDCP,
a hyper frame number (HFN),
a count value, or
information related sequence number of the PDCP.

13. The first node of claim 12, wherein the information related to sequence number of the PDCP is a highest sequence number of the PDCP that has been successfully transmitted, a sequence number of the PDCP corresponding to a data packet to be transmitted next, or a recommended sequence number of the PDCP.

14. The first node of claim 8, wherein the controller is further configured to:
broadcast an identification of a multimedia broadcast service (MBS) service, information configuring a PDCP, and a PDCP re-establishment indication.
